(19) United States
(12) Patent Application Publication
(10) Pub. No.: US 2022/0114424 A1
(43) Pub. Date: Apr. 14, 2022

(54) MULTI-BANDWIDTH SEPARATED FEATURE EXTRACTION CONVOLUTION LAYER FOR CONVOLUTIONAL NEURAL NETWORKS

(71) Applicants: Niamul QUADER, Toronto (CA); Md Ibrahim KHALIL, Toronto (CA); Juwei LU, North York (CA); Peng DAI, Markham (CA); Wei LI, Markham (CA)

(72) Inventors: Niamul QUADER, Toronto (CA); Md Ibrahim KHALIL, Toronto (CA); Juwei LU, North York (CA); Peng DAI, Markham (CA); Wei LI, Markham (CA)

(21) Appl. No.: 17/066,220

(22) Filed: Oct. 8, 2020

(51) Int. Cl. G06N 3/04; G06N 3/08; G06N 5/04; G06F 17/14

(52) U.S. Cl. CPC G06N 3/0481; G06F 17/14; G06N 5/046; G06N 3/084

(57) ABSTRACT

Methods, processing units and media for multi-bandwidth separated feature extraction convolution in a neural network are described. A convolution block splits input channels of an activation map into multiple branches, each branch undergoing convolution at a different bandwidth by using down-sampling of the inputs. The outputs are concatenated by up-sampling the outputs of the low-bandwidth branches using pixel shuffling. The concatenation operation may be a shuffled concatenation operation that preserves separated multi-bandwidth feature information for use by subsequent layers of the neural network. Embodiments are described which apply frequency-based and magnitude-based attention to the weights of the convolution kernels based on the frequency band locations of the weights.

### FIELD

The present disclosure relates to artificial neural networks, including convolutional neural networks. In particular, the present disclosure relates to a multi-bandwidth separated feature extraction layer for convolutional neural networks.

### BACKGROUND

Convolutional neural networks (CNNs) are types of neural network generally used for processing data that has a known, grid-like topology, such as image data or point cloud data. A CNN performs convolution operations using convolution kernel (also called filters). A set of convolution operations performed by one or more convolution kernels on a single input may be referred to as a convolution layer. One or more convolution layers, along with one or more additional data operations before or after the convolution kernels are applied, may be collectively called a convolution block.

A convolution layer receives a data input, usually in the form of a data array of known dimensions called a feature map or activation map, and by applying the convolution kernels to perform convolution operations on the input, generates a data output, typically a data array having known dimensions and also called a feature map or activation map. As noted above, one or more additional data operations of the convolution block may also be applied to the data input of the convolution layer and/or to the data output of the convolution layer.

A convolution kernel comprises a set of weights (also called parameters), and training a CNN involves learning the optimized values of the set of weights of the convolution kernels of the CNN. If the values of the weights are not properly learned during training of the CNN (e.g., high value weights are misplaced by training), then the trained CNN will perform with less accuracy.

The convolution operations performed by each convolution kernel on an input feature or activation map extract features from the input feature or activation map based on the learned weights of the convolution kernel. For many types of input feature or activation maps, the features of interest may occur across many different scales or bandwidths. For example, in the context of computer vision, a classification task may require the CNN to identify both fine-grained features (e.g. whiskers) and coarse-grained features (e.g. body outline) in order to accurately classify an object in the input image data (e.g. “cat”). For a deep CNN, there may be many convolutional layers, many convolutional kernels for each convolutional layer, and many weights in each convolution kernel, meaning there may be a very large number of weights to learn. Furthermore, using the trained CNN to perform inference (i.e. prediction) on a new input feature or activation map at runtime requires the execution of a large number of convolution operations applying a convolution kernel having a large number of weights. The memory and computing power required to perform inference (i.e. prediction) using a large CNN (i.e. a CNN with many weights) may be prohibitive for many hardware platforms. Thus, there is a problem of how to reduce the number of weights that need to be learned, and the number of learned weights that need to be applied at runtime, yet retain the ability of the CNN to accurately extract features present at multiple different frequency bands or bandwidths.

Some techniques have been developed for performing convolution operations at multiple bandwidths within a convolution block using a smaller number of convolutional weights than a conventional convolution block. However, these techniques result in convolution block data outputs having multiple different dimensions, some of which are different from the dimensions of the data output of a conventional convolution block. This leads to a further problem of how to combine the data outputs to allow them to be processed by subsequent layers of a convolutional block of the CNN.

Furthermore, some bandwidths or frequency bands are more important than others depending on the task the CNN is trained for (e.g. identifying sharp objects such as whiskers of a cat will likely result in the high frequency spectrum processing to be more dominant). It is more important that convolution weights corresponding to these important frequency bands are learned better than other frequency bands that are less important for the task performed by the CNN. Previous multiple bandwidth approaches do not offer any mechanism to focus more on correctly learning the convolutional weights for more important frequency bands. Thus, there is a problem of how to focus CNN training on learning convolutional weights of convolutional layers of the CNN that contribute to extraction of features at important frequency bands.

### SUMMARY

In various examples, the present disclosure describes methods, processing units and processor-readable media for performing operations of a multi-bandwidth separated feature extraction convolution layer in a convolution block of a CNN. A multi-bandwidth separated feature extraction convolution layer receives an input activation map comprising a plurality of channels, splits the plurality of input channels of the input activation map into multiple different sets of input channels for processing by a different branches of the multi-bandwidth separated feature extraction convolution layer. Each branch of the multi-bandwidth separated feature extraction convolution layer receives a set of the input channels and performs convolution at a different bandwidth by down-sampling of each input channel of the set of input channels. The outputs of each branch of the multi-bandwidth separated feature extraction convolution layer are concatenated by up-sampling the outputs of the low-bandwidth branches using pixel shuffling. The concatenation operation may be a shuffled concatenation operation that preserves separated multi-bandwidth feature information for use by subsequent layers of the convolutional block of a CNN. Embodiments of the multi-bandwidth separated feature extraction convolution layer are described which perform further refinement of the up-sampled low-bandwidth outputs using the convolution operations of the higher-bandwidth branches. Embodiments of the multi-bandwidth separated feature extraction convolution layer are described which apply frequency-based and magnitude-based attention to the weights of the convolution kernels based on the frequency band locations of the weights of the convolution kernels. Embodiments of the multi-bandwidth separated feature extraction convolution layer are described which perform 3D multi-bandwidth convolution.

As used herein, the term “bandwidth” refers to a range of frequencies in input data that are salient to the feature extraction operations of the convolution kernels of a convolution layer. For example, in the context of an object classification task performed on image data, high-frequency feature extraction may extract fine-grained details in the image data, such as the texture of a cat's fur or the locations of its whiskers, whereas low-frequency feature extraction may extract coarse-grained features of the image data, such as the body shape of a cat or a light gradient across an entire image. A high-bandwidth feature extraction operation may therefore extract both high- and low-frequency features, whereas a low-bandwidth feature extraction operation may only extract low-frequency features. In the context of the present disclosure, a “full bandwidth” convolution operation refers to a relatively high-bandwidth convolution operation performed on full-sized channels of an input activation map (i.e., channels having the same height and width as the input activation map), and reduced-bandwidth convolution (e.g., half-bandwidth or quarter-bandwidth) refers to a relatively low-bandwidth convolution operation performed on reduced-sized channels of an input activation map (i.e., channels having a smaller height and width than the input activation map due to down-sampling).

As used herein, the term “convolve” refers to performing a convolution operation. Thus, for example, convolving a convolution kernel with an input activation map refers to traversing the input activation map with the convolution kernel to perform a convolution operation on the input activation map using the convolution kernel, thereby generating an output activation map.

Performance of a CNN that includes a multi-bandwidth separated feature extraction convolution layer in accordance with the present disclosure may be improved, including increasing accuracy of the CNN, decreasing memory use, and/or decreasing computation cost for performing the operations of the CNN. The multi-band width separated feature extraction convolution layer may be substituted for a conventional convolution layer in existing convolution blocks of a CNN, as the multi-bandwidth separated feature extraction convolutional layer receives input activation maps and generates output activation maps having the same dimensions as a conventional convolution layer.

In some aspects, the present disclosure described a method for performing operations of a multi-bandwidth separated feature extraction convolutional layer of a convolutional neural network. An input activation map is received, comprising a plurality of input channels. The plurality of input channels are grouped into a plurality of subsets of input channels including a first subset of input channels and a second subset of input channels. Each respective input channel of the first subset of input channels is convolved with each convolutional kernel of a first set of convolution kernels to generate a set of full-bandwidth output channels. Each respective input channel of the second subset of input channels is down-sampled by a scaling factor to generate a first set of down-sampled channels. Each respective down-sampled channel is convolved with each convolution kernel of a second set of convolution kernels to generate a set of down-sampled output channels. Each down-sampled output channel has a smaller number of elements, by a factor of the scaling factor, than one of the full-bandwidth output channels. For each respective down-sampled output channel of the set of down-sampled output channels, the pixels of the respective down-sampled output channel are shuffled into an up-sampled output channel having the same size as a full-bandwidth output channel, thereby generating a first set of up-sampled output channels. An output activation map is generated by concatenating the set of full-bandwidth output channels and the first set of up-sampled output channels.

In some aspects, the present disclosure described a system for performing operations of a multi-bandwidth separated feature extraction convolutional layer of a convolutional neural network. The system comprises a processor and a memory. The memory stores instructions that, when executed by the processor, perform a number of steps. An input activation map is received, comprising a plurality of input channels. The plurality of input channels are grouped into a plurality of subsets of input channels including a first subset of input channels and a second subset of input channels. Each respective input channel of the first subset of input channels is convolved with each convolutional kernel of a first set of convolution kernels to generate a set of full-bandwidth output channels. Each respective input channel of the second subset of input channels is down-sampled by a scaling factor to generate a first set of down-sampled channels. Each respective down-sampled channel is convolved with each convolution kernel of a second set of convolution kernels to generate a set of down-sampled output channels. Each down-sampled output channel has a smaller number of elements, by a factor of the scaling factor, than one of the full-bandwidth output channels. For each respective down-sampled output channel of the set of down-sampled output channels, the pixels of the respective down-sampled output channel are shuffled into an up-sampled output channel having the same size as a full-bandwidth output channel, thereby generating a first set of up-sampled output channels. An output activation map is generated by concatenating the set of full-bandwidth output channels and the first set of up-sampled output channels.

According to a further aspect, the method further comprises further grouping the plurality of input channels into one or more additional subsets of input channels, and for each additional subset of input channels, down-sampling each input channel of the additional subset of input channels by a distinct additional scaling factor to generate an additional set of down-sampled channels, convolving the down-sampled channels with a distinct additional set of convolution kernels to generate an additional set of down-sampled output channels (each down-sampled output channel having a smaller number of elements, by a factor of the distinct additional scaling factor, than one of the full-bandwidth output channels), and for each respective down-sampled output channel, shuffling the pixels of the respective down-sampled output channel into a single up-sampled output channel having the same size as a full-bandwidth output channel, thereby generating an additional set of up-sampled output channels. Generating the output activation map further comprises concatenating each additional set of up-sampled output channels with the set of full-bandwidth output channels and the first set of up-sampled output channels.

According to a further aspect, shuffling the pixels of a set of down-sampled channels into a single up-sampled output channel comprises generating an output channel comprising a plurality of pixel clusters, each pixel cluster comprising one pixel selected from each down-sampled channel of the set of down-sampled channels.

According to a further aspect, the method further comprises using the output activation map to generate an inference, calculating a loss function based on the inference, and updating each set of convolution kernels based on the calculated loss function.

According to a further aspect, the method further comprises, for each set of convolution kernels, prior to convolving each subset of input channels with its respective set of convolution kernels: learning a set of frequency-based attention multipliers, applying the set of frequency-based attention multipliers to the weights of the set of convolution kernels, and applying a magnitude-based attention function to the weights of the set of convolution kernels.

According to a further aspect, the method may also include, prior to calculating the loss function, applying a frequency-based attention function to the output activation map.

According to a further aspect, learning each set of frequency-based attention multipliers comprises: standardizing the weights in the set of convolution kernels; applying a Fourier transform function to the set of convolution kernels to generate a set of frequency-domain convolution kernels; performing average pooling to obtain an averaged weight for each frequency-domain convolution kernel; feeding the averaged weights of the frequency-domain convolution kernels through one or more fully connected layers, to learn the attention multiplier for each frequency-domain convolution kernel; and expanding the attention multiplier across all weights in each respective convolution kernel to obtain the set of frequency-based attention multipliers. Applying the set of frequency-based attention multipliers to the weights of each set of convolution kernels comprises: multiplying the set of frequency-based attention multipliers by the set of frequency-domain convolution kernels to generate a set of attention-infused frequency-domain convolution kernels; and applying a reverse Fourier transform function to the set of attention-infused frequency-domain convolution kernels.

According to a further aspect, there are two fully connected layers for learning the attention multiplier for each convolution kernel; the magnitude-based attention function applies greater attention to weights of greater magnitude, and lesser attention to weights of lesser magnitude; and the magnitude-based attention function is

$${w}_{A} = {f}_{A} ( {w}_{m} ) = {M}_{A} * 0.5 * ln \frac{1 + {w}_{m} / {M}_{A}}{1 - {w}_{m} / {M}_{A}}$$

wherein wₘ is a weight for a convolution kernel, w_{A} is the weight after applying magnitude-based attention, M_{A}=(1+ϵ_{A})*M, M is the maximum of all wₘ in a convolution layer and ϵ_{A} is a hyperparameter with a selected small value.

According to a further aspect, concatenating the set of full-bandwidth output channels and the first set of up-sampled output channels to generate the output activation map comprises: receiving the set of full-bandwidth output channels and the first set of up-sampled output channels at a shuffled concatenation block; and concatenating the output channels of the set of full-bandwidth output channels and the output channels of the first set of up-sampled output channels according to a shuffling pattern such that at least one output channel of the first set of up-sampled output channels is concatenated in order after a first output channel of the set of full-bandwidth output channels and in order before a second output channel of the set of full-bandwidth output channels.

According to a further aspect, the shuffling pattern is a skip-by-5 shuffling pattern, S being a positive integer.

In some aspects, the present disclosure describes a computer-readable medium having instructions tangibly stored thereon. The instructions, when executed by a processing unit, cause the processing unit to perform any of the methods described herein.

### BRIEF DESCRIPTION OF THE DRAWINGS

Reference will now be made, by way of example, to the accompanying drawings which show example embodiments of the present application, and in which:

FIG. 1A is a block diagram of an example processing system that may be used to implement examples described herein;

FIG. 1B is a schematic diagram of an example architecture of a CNN;

FIG. 1C is a schematic diagram of a conventional convolution layer of convolution block showing the dimensions of an input data array, an output data array, and a set of convolution kernels applied by the convolution block;

FIG. 2A is a schematic diagram of a first example multi-bandwidth separated feature extraction convolution layer in accordance with the present disclosure, showing the dimensions of the inputs and outputs of each functional sub-block as well as the convolution kernels used in each convolution sub-block;

FIG. 2B is a schematic diagram of a second example multi-bandwidth separated feature extraction convolution layer in accordance with the present disclosure, showing the use of recursive input splitting, recursive down-sampling, and recursive up-sampling;

FIG. 2C is a flowchart illustrating an example method for operating the second example multi-bandwidth convolution layer of FIG. 2B; and

FIG. 3A shows example operations that may be performed by a Squeeze-and-Excitation block of a Squeeze-and-Excitation neural network;

FIG. 3B shows example operations that may be performed by a multi-bandwidth separated feature extraction convolution layer, in accordance with the present disclosure;

FIG. 4 is a flowchart illustrating an example method for training a multi-bandwidth separated feature extraction convolution layer, in accordance with the present disclosure;

FIG. 5 is a flowchart illustrating an example method for learning a frequency-based attention multiplier, which may be part of the method of FIG. 4; and

FIG. 6 is a plot illustrating an example function for applying magnitude-based attention to weights, which may be used for the method of FIG. 4.

FIG. 7A is a flowchart illustrating a method for recursive shuffled concatenation of output channels from multiple branches of a multi-bandwidth convolution block to form a shuffled output activation map, in accordance with the present disclosure;

FIG. 7B is a flowchart illustrating a method for non-recursive shuffled concatenation of output channels from multiple branches of a multi-bandwidth convolution block to form a shuffled output activation map, in accordance with the present disclosure;

FIG. 8 is a flowchart illustrating a method for multi-bandwidth separated 3D convolution using a 3D multi-bandwidth separated feature extraction convolution layer employing shuffled concatenation, in accordance with the present disclosure;

Similar reference numerals may have been used in different figures to denote similar components.

### DESCRIPTION OF EXAMPLE EMBODIMENTS

In examples described herein, performance of a convolutional neural network (CNN) that includes a multi-bandwidth separated feature extraction convolution layer in accordance with the present disclosure may be improved, including increasing accuracy of the CNN, decreasing memory use, and/or decreasing computation resources required to perform convolution operations of the CNN.

A CNN that includes one or more multi-bandwidth separated feature extraction convolution layers is trained in accordance with examples disclosed herein. For simplicity, the present disclosure will refer to the multi-bandwidth separated feature extraction convolution layer by itself, however it should be understood that the multi-bandwidth separated feature extraction convolution layer may be part of a convolution block of a CNN comprising conventional convolution blocks and fully connected blocks, and training of the may be part of training of the CNN. Further, the present disclosure may use the term CNN to include deep CNN.

Examples described herein may be applicable for training a CNN to perform various tasks including object classification, object detection, semantic segmentation, gesture recognition, action recognition, and other applications where CNNs may be used.

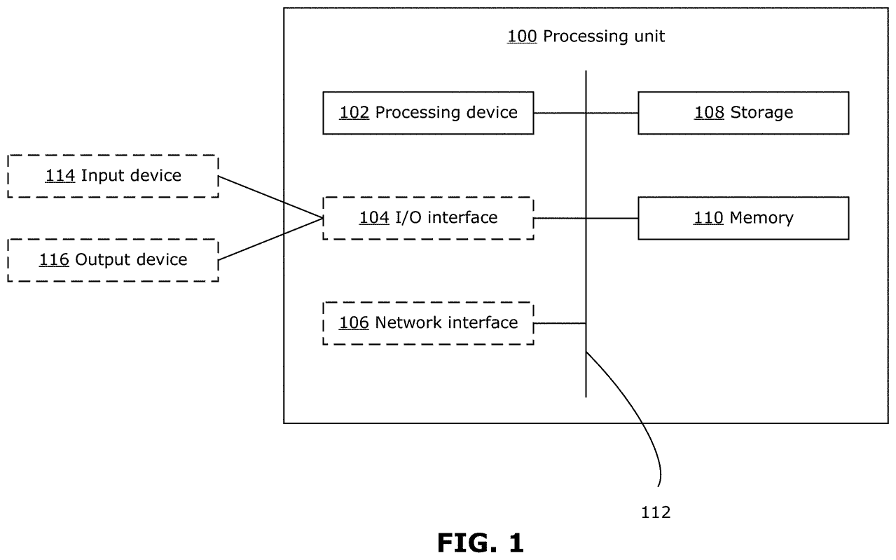

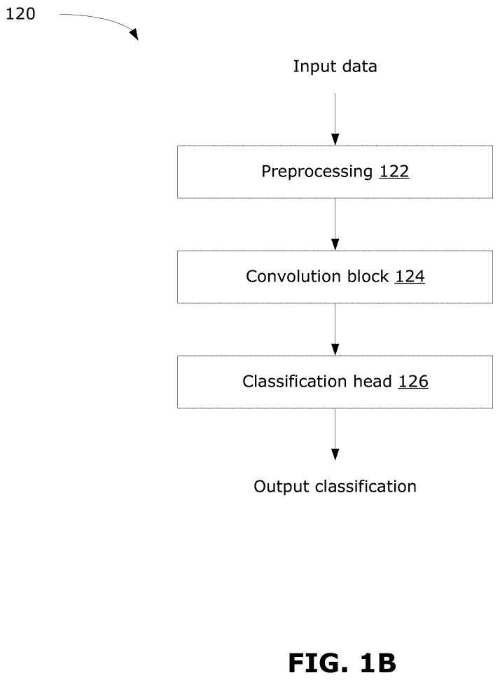

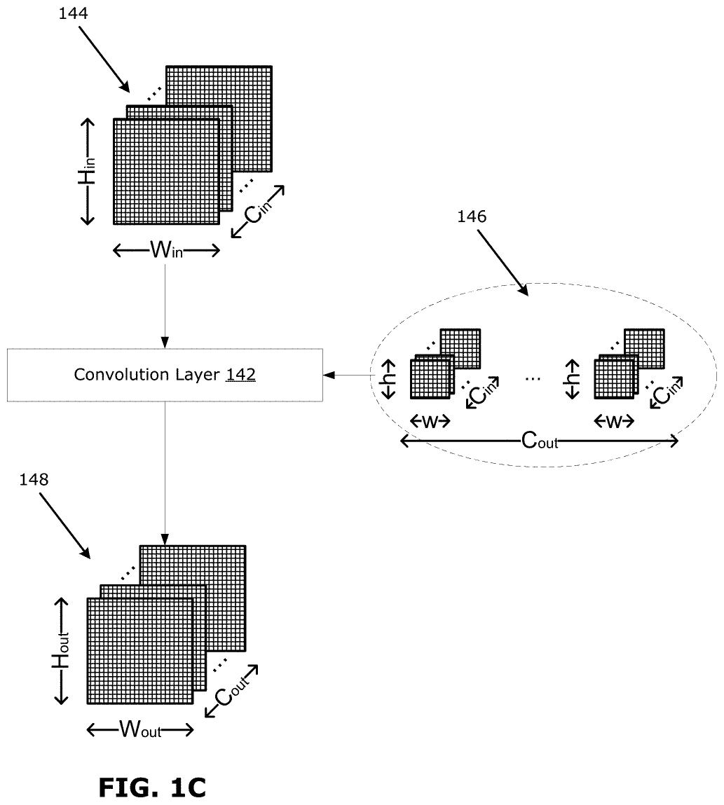

FIG. 1A shows a block diagram of an example simplified processing unit 100, which may be part of a system that is used to perform operations to train a CNN including one or more multi-bandwidth separated feature extraction convolution layer to perform a specific task (e.g. object detection, object classification, object detection, semantic segmentation, gesture recognition, action recognition) in accordance with examples disclosed herein and/or to perform operations of a trained CNN including one or more multi-bandwidth separated feature extraction convolution block perform the specific task for which the CNN has been trained. Other processing units suitable for implementing embodiments described in the present disclosure may be used, which may include components different from those discussed below. Although FIG. 1A shows a single instance of each component, there may be multiple instances of each component in the processing unit 100.

The processing unit 100 may include one or more processing devices 102, such as a processor, a microprocessor, a tensor processing unit, a graphics processing unit, a neural processing unit, a hardware accelerator, an application-specific integrated circuit (ASIC), a field-programmable gate array (FPGA), a dedicated logic circuitry, a dedicated artificial intelligence processor unit, or combinations thereof. The processing unit 100 may also include one or more optional input/output (I/O) interfaces 104, which may enable interfacing with one or more optional input devices 114 and/or optional output devices 116.

In the example shown, the input device(s) 114 (e.g., a keyboard, a mouse, a microphone, a touchscreen, and/or a keypad) and output device(s) 116 (e.g., a display, a speaker and/or a printer) are shown as optional and external to the processing unit 100. In other examples, one or more of the input device(s) 114 and/or the output device(s) 116 may be included as a component of the processing unit 100. In other examples, there may not be any input device(s) 114 and output device(s) 116, in which case the I/O interface(s) 104 may not be needed.

The processing unit 100 may include one or more optional network interfaces 106 for wired or wireless communication with a network (e.g., an intranet, the Internet, a P2P network, a WAN and/or a LAN) or other node. The network interfaces 106 may include wired links (e.g., Ethernet cable) and/or wireless links (e.g., one or more antennas) for intra-network and/or inter-network communications.

The processing unit 100 may also include one or more storage units 108, which may include a mass storage unit such as a solid state drive, a hard disk drive, a magnetic disk drive and/or an optical disk drive. The processing unit 100 may include one or more memories 110, which may include a volatile or non-volatile memory (e.g., a flash memory, a random access memory (RAM), and/or a read-only memory (ROM)). The non-transitory memory(ies) 110 may store instructions for execution by the processing device(s) 102, such as to carry out examples described in the present disclosure. The memory(ies) 110 may include other software instructions, such as for implementing an operating system and other applications/functions. In some examples, memory 110 may include software instructions for execution by the processing device 102 to train a convolutional neural network and/or to implement a trained convolutional neural network, as disclosed herein.

In some other examples, one or more data sets and/or modules may be provided by an external memory (e.g., an external drive in wired or wireless communication with the processing unit 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 112 providing communication among components of the processing unit 100, including the processing device(s) 102, optional I/O interface(s) 104, optional network interface(s) 106, storage unit(s) 108 and/or memory(ies) 110. The bus 112 may be any suitable bus architecture including, for example, a memory bus, a peripheral bus or a video bus.

FIG. 1B illustrates an example architecture of a CNN 120, which includes one or more multi-bandwidth separated feature extraction convolution layers. The CNN 120 in this example is designed for performing a particular task (e.g., object classification in this example). The CNN 120 has been simplified, is not intended to be limiting and is provided for the purpose of illustration only. The input data to the CNN 120 may be, for example, image data (as in this example), video data, audio data, or text data. The CNN 120 includes a preprocessing block 122, which may perform various preprocessing operations (e.g., normalization) on the input data to generate an input activation map for the convolution block 124. The convolution block 124 receives an input activation map (e.g., the preprocessed input data) and performs convolution operations, using convolution kernels, to generate an output activation map. As will be discussed further below, the convolution kernels (which may also be referred to as filter kernels or simply filters) each include a set of weights. Training of the CNN is performed in order to learn the weights for each convolution kernel in the CNN. The output activation map is provided to a classification head 126, which may then output a label indicative of the class of an object represented by the output activation map generated by the last convolution block 124.

The above discussion provides an example that illustrates how a trained CNN may be used to generate predictions during inference. In general the input data (i.e., activation map) may have one, two or three (or more) dimensions, and the output activation map may have any suitable format, depending on the application. The example embodiments herein shall be described on the context of a CNN used to perform a computer vision task, such as object detection. A CNN block 124 receiving input activation maps and generating output activation maps in the form of multi-channel 2D pixel arrays (i.e., 3D arrays defined by a pixel height, a pixel width, and a channel depth). However, it will be appreciated that other multi-channel data arrays may be used as input or output in some embodiments, such as multi-channel 1D arrays for tasks involving e.g. audio or text inputs.

In order for the CNN 120 to perform the specific task with a desired degree of accuracy, the approach used for training of the CNN 120 is important. A trained CNN that includes one or more multi-bandwidth feature extraction convolution layers in accordance with examples of the present disclosure have been found to have improvements over baseline performance of some existing trained CNNs that include only convolution blocks that include conventional convolution layers, on a number of computer vision tasks such as object classification. Such improvements may include increased accuracy of the trained CNN, decreased memory usage, decreased computation cost when performing operations of the trained CNN, increased receptive field, and increased network width. Receptive field refers to the size of the portion of an input activation map that is mapped to a portion of the output activation map by a kernel of a convolution layer; in practice, it refers to the kernel size relative to the input activation map size, which, in examples described herein, may be increased when kernels of fixed width and height dimensions are applied to down-sampled (i.e. reduced-size) input activation map channels. Network width refers to the number of kernels per convolution layer in a CNN; examples described herein may use more kernels operating on smaller activation maps to achieve greater effective network width without increasing the required computational resources.

The convolution block 124 may include several layers, including one or more multi-bandwidth feature extraction convolution layers, conventional convolution layers, and other layers, such as an activation layer, a batch normalization layer, and so on. The classification head 126 may include one or more layers, such as one or more fully connected layers, a SoftMax layer, and so on. The CNN 120 may include more than one convolution block, as well as additional blocks or layers. It will be appreciated that the structure of the CNN 120 shown in FIG. 1B is intended as a simplified representation of a CNN.

FIG. 1C illustrates a conventional convolution layer 142 of a convolution block, showing the dimensions of an input data array 144, an output data array 148, and a set of convolution kernels 146 applied by the conventional convolution layer 142. The input data array 144 is shown here as a multi-channel input activation map having a number of input channels equal to value Cm. Each channel of the input data array 144 consists of a 2D array, such as an image consisting of a 2D pixel array, having a height Hᵢₙ and a width Wᵢₙ. Thus, the number of values stored in the input data array 144 is equal to (Hᵢₙ×Wᵢₙ×Cᵢₙ). The convolution kernels 146 applied to the input data array 144 each have a set of kernel dimensions, namely height h, a width w, and channel depth Cᵢₙ. The conventional convolution layer 142 uses a number of convolution kernels 146 equal to value Cₒᵤₜ.

The conventional convolution layer 142 applies the convolution kernels 146 to the input data array 144 in a series of convolution operations. Each convolution kernel 146 is applied to the input data array 144 to generate a channel of the output data array 148, shown here as a multi-channel output activation map having a number of output channels equal to value Cₒᵤₜ. Each channel of the output data array 148 consists of a 2D array, such as an image consisting of a 2D pixel array, having a height Hₒᵤₜ and a width Wₒᵤₜ. The relationships between Hᵢₙ and Hₒᵤₜ, and between Wᵢₙ and Wₒᵤₜ, are determined by the kernel dimensions h and w and the stride, padding, and other convolution configurations used by the convolution operations of the conventional convolution layer 142. In some embodiments, Hᵢₙ=Hₒᵤₜ, and Wᵢₙ=Wₒᵤₜ. For example, an example embodiment may use a kernel having dimensions h=3 and w=3, with padding of 1 pixel and stride 1, to generate an output data array wherein Hᵢₙ=Hₒᵤₜ, and Wᵢₙ=Wₒᵤₜ. The use of a conventional convolution layer 142 wherein Hᵢₙ=Hₒᵤₜ, and Wᵢₙ=Wₒᵤₜ may present certain advantages, for example in embodiments using hardware or software components optimized to process input channels having fixed dimensions.

Multi-Bandwidth Separated Feature Extraction Convolution

In various examples, the present disclosure describes a multi-bandwidth separated feature extraction convolution layer for a convolution block of a CNN (also referred to herein as a “multi-bandwidth convolution layer”) for extracting features from an input activation map at multiple bandwidths. The multi-bandwidth convolution block receives an input activation map comprising a plurality of channels and performs grouping of the channels of an input activation map into full-bandwidth channels and reduced-bandwidth channels to reduce the size of each subset of input activation map channels and the convolution kernels used to perform convolution on each subset of input activation map channels, resulting in decreased memory requirements to store the set of weights of the convolutional kernels and decreased computation costs to perform the convolution operations.

Furthermore, each set of input channels resulting from the grouping operation of the input activation map channels undergoes convolution at a different scale, further reducing computation costs while increasing accuracy of the CNN due to extraction of features at different bandwidths. The use of convolution operations at multiple different bandwidths may also increase the receptive field and network width of the multi-bandwidth convolution layer, as described above, thereby increasing the number of features generated by the multi-bandwidth convolution layer.

The multi-bandwidth convolution layer includes an up-sampling operation to scale the output channels generated by the different convolution operations to match the dimensions of the output channels generated by a conventional convolution layer, such as convolution layer 142 in FIG. 1C. The output channels generated by the convolution and up-sampling operations are concatenated together to generate an output activation map having the same dimensions as the output activation map 148 of the convolution layer 142 in FIG. 1C. Because the multi-bandwidth convolution layer of the present disclosure receives an input activation map with the same dimensions as the input activation map 144 received by a conventional convolution layer 142, and generates an output activation map with the same dimensions as the output activation map 148 generated by the conventional convolution layer 142, the multi-bandwidth convolution layer can be used to replace a conventional convolution layer 142 within a convolution block of a CNN without any further modification or adaptation to the convolution block.

It will be appreciated that references made herein to a CNN, any neural network are equally applicable to a multi-bandwidth convolution layer in accordance with example embodiments described herein.

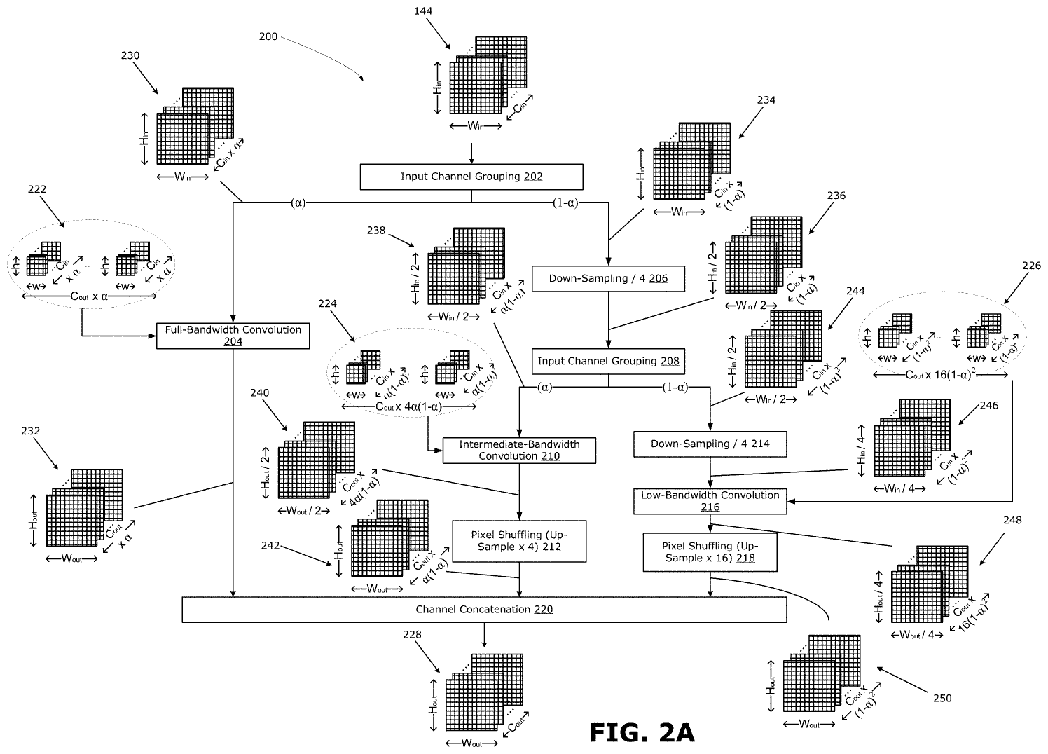

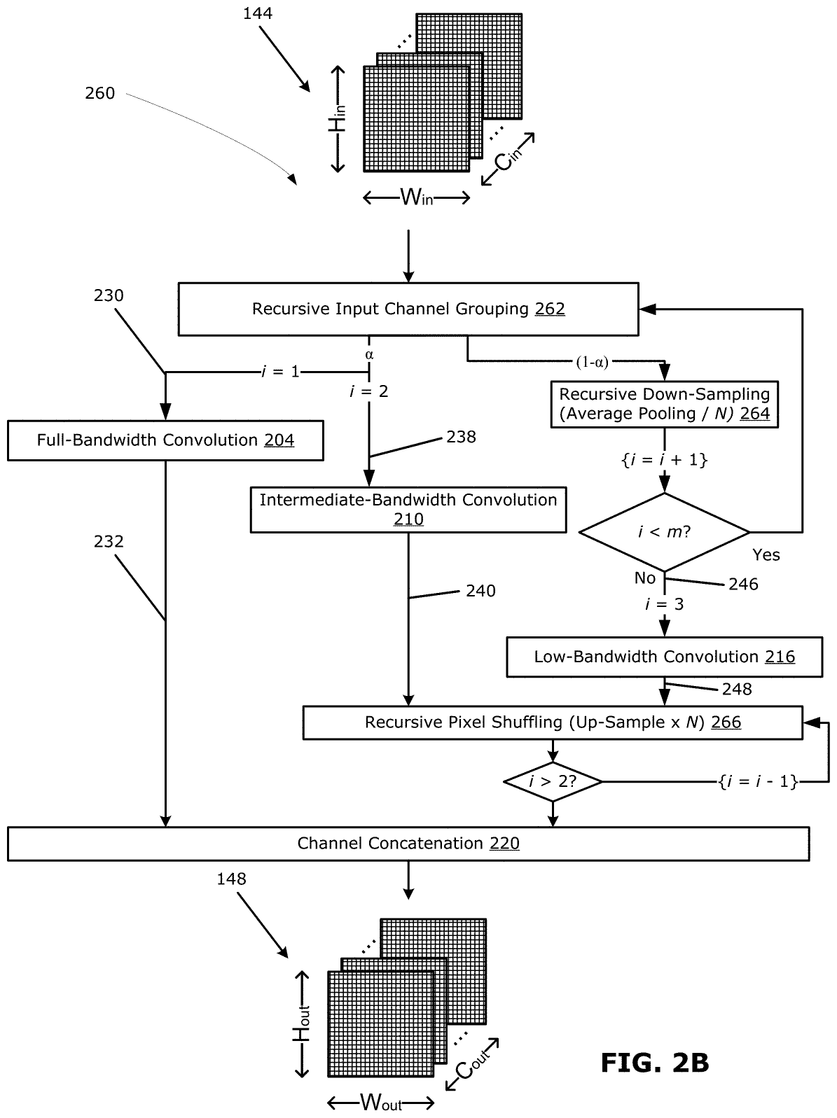

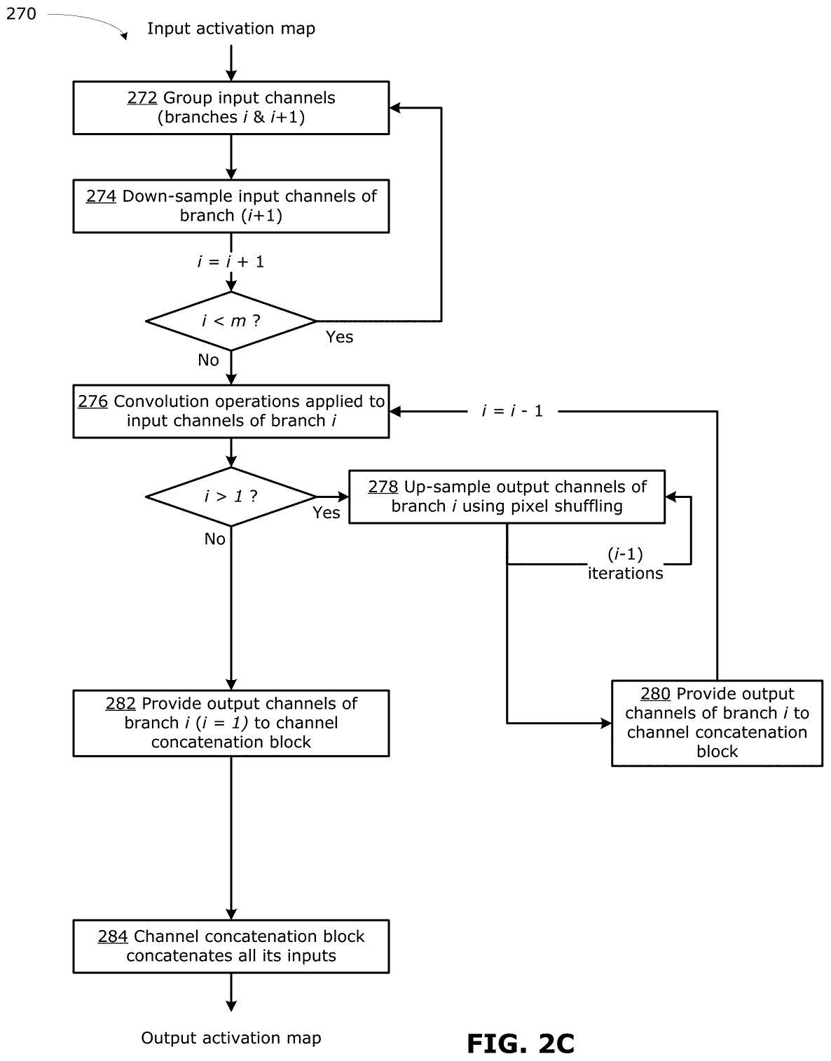

FIG. 2A illustrates a first example multi-bandwidth convolution layer 200, showing the dimensions of the inputs and outputs of each functional block within the multi-bandwidth convolution layer 200 as well as the number and dimensions of the convolution kernels used by each convolution. As noted above, the input activation map 144 and output activation map 228 are identical in their dimensions to those received and generated by the conventional convolution layer 142 of FIG. 1C.

The multi-bandwidth convolution layer 200 operates by grouping the input channels of the input activation map 144 into two or more subsets. One of the subsets undergoes a convolution operation at full bandwidth (as defined above), and each subsequent subset undergoes a convolution operation at a lower bandwidth than the previous subset. The number of subsets is represented by value m. A multi-bandwidth convolution layer 200 with m=1 does not split the input channels into groups or subsets and applies a single full-bandwidth convolution operation to all input channels—it is functionally equivalent to the conventional convolution layer 142 of FIG. 1C. A multi-bandwidth convolution layer 200 with m=2 groups the input channels into two subsets, with one subset undergoing a convolution operation at full bandwidth and another subset undergoing a convolution operation at a once-reduced bandwidth. A multi-bandwidth convolution layer 200 with m=3 also groups the input channels into three subsets, with the third subset undergoing a convolution operation at a twice-reduced bandwidth. Each subset is processed by a different branch of the flowchart of FIG. 2A, such that the number of subsets m is also equal to the number of branches.

The number of input channels grouped into each subset is determined by value a (alpha) between 0 and 1. The first subset (which undergoes convolution at full bandwidth in the first branch) is allocated a number of input channels proportional to a, whereas the second subset (which undergoes convolution at once-reduced bandwidth in the second branch) is allocated a number of input channels proportional to (1−α). Thus, if α=0.875 and the input activation map 144 has 64 input channels (Cᵢₙ=64), then the first branch processes (64×0.875=56) 56 input channels, and the second branch processes (64×0.125=8) 8 input channels, each input channel having height Hᵢₙ and width Wᵢₙ. If m=3, the second branch processes (8×0.875=7) 7 input channels, and the third branch processes (8×0.125=1) 1 input channel.

The bandwidth reduction performed on the second and third subsets by the second and subsequent branches is accomplished by down-sampling the input channels allocated to the second and subsequent subsets, respectively, to generate lower-bandwidth input channels. Each input channel is down-sampled by a scaling factor N: thus, the second branch performs a convolution operation on the second subset of channels having (1/N) times the bandwidth of the input channels of the input activation map 144, whereas the third branch performs a convolution operation on the third subset of channels having (1/N²) times the bandwidth of the input channels of the input activation map 144, due to being down-sampled by a factor of N twice. In the first example multi-bandwidth convolution layer 200 shown in FIG. 2A, the bandwidth reduction performed by the second branch is accomplished by down-sampling the 2D pixel array of each channel of the second subset using stride equal to 2 in the height and width dimensions, resulting in each down-sampled input channel in the second subset having height (Hᵢₙ/2) and width (Wᵢₙ/2), and therefore being scaled down in size by a factor of 4 (i.e., N=4 in the illustrated embodiment). Accordingly, the bandwidth reduction performed by the third branch is accomplished by down-sampling each channel in the third subset having height (Hᵢₙ/2) and width (Wᵢₙ/2) by a further factor of 4. The third branch performs convolution operations on down-sampled input channels having height (Hᵢₙ/4) and width (Wᵢₙ/4), and therefore being scaled down in size by a factor of 16 (i.e., N²=16).

Some embodiments may not group the input channels into subsets or down-sample the subsets of channels according to the regular patterns dictated by the values m, α, and N described above. Instead, such embodiments may include an arbitrary number of branches processing an arbitrary number of subsets of input channels, each subset including an arbitrary proportion of the input channels of the input activation map 144, and/or each branch down-sampling its input channels by an arbitrary scaling factor. However, there may be advantages to utilizing the values m, α, and N as described above, as this may enable some embodiments to perform the input channel grouping, down-sampling, and/or up-sampling operations in a recursive fashion, thereby potentially re-using the corresponding functional blocks of the convolution block more effectively, as further described below with reference to FIG. 2B.

Returning to FIG. 2A, the illustrated first example multi-bandwidth convolution layer 200 is configured with values m=3 and N=4. This means that the multi-bandwidth convolution layer 200 includes three branches, each branch receiving a subset of input channels and each branch performing a respective convolution operation of a set of convolution operations with a respective input channel of the subset of the input channels, with each branch after the first applying its convolution operations at a pixel resolution decreased by a factor of 4 (i.e. halved bandwidth in the width and height dimensions) relative to the previous branch. The value of a is not specified, but any specific instance of such a multi-bandwidth convolution layer 200 would need to define the value of α, as this value would dictate the dimensions of the convolution kernels used by each branch.

The initial input channel grouping operation is performed on the input activation map 144 by a first input channel grouping block 202. The Cᵢₙ channels of the input activation map 144 are grouped into a first subset of inputs channels 230 consisting of the first (Cᵢₙ×α) input channels, and a second subset of inputs channels 234 consisting of the remaining (Cᵢₙ×(1−α)) input channels. Each input channel of the first subset 230 and second subset 234 has height Hᵢₙ and width Wᵢₙ.

Some embodiments may use a channel allocation process different from the one described above. For example, instead of allocating the first (Cᵢₙ×α) input channels to the first subset 230, some embodiments may allocate the last (Cᵢₙ×α) input channels, or (Cᵢₙ×α) input channels selected from the full set of Cᵢₙ input channels in some other way, such as at proportional intervals.

A full-bandwidth convolution sub-block 204 uses a first set of convolution filters 222 to perform a set of convolution operations on the first subset of input channels 230. The first set of convolution filters 222 consists of a number of convolution kernels equal to αCₒᵤₜ, each convolution kernel having dimensions h×w×(Cᵢₙ×α). (A set of convolution kernels may also be referred to as a 4D weight tensor, wherein the 4 dimensions are height, weight, depth, and the number of convolution kernels: in this example, the first set of convolution filters 222 is a 4d weight tensor with dimensions h×w×αCᵢₙ×αCₒᵤₜ. These dimensions denote the number of weights in the convolution kernel.) Because the depth of the convolution kernels are smaller than those used by the conventional convolution layer 142, the number of weights in the convolution kernel is reduced. This reduces the memory requirements for storing the parameters of a CNN comprising one or more multi-bandwidth convolution layers relative to a CNN that includes only includes conventional convolution layers 142, even after adding the additional weights of the convolution kernels used by the second and subsequent branches described below. Furthermore, the computing power required to perform the convolution operations on the first subset of input channels 230 is reduced due to the reduced depth of the convolution kernels and the input channels, even after taking into account the additional computing power required to perform the convolution operations of the second and subsequent branches described below.

The convolution operations performed by the full-bandwidth convolution sub-block 204 generate a first set of output channels 232 (which may be referred to herein as “full-bandwidth output channels”). The first set of output channels 232 consists of (Cₒᵤₜ×α) output channels (i.e. one for each kernel in the first branch), each having height Hₒᵤₜ and width Wₒᵤₜ.

The second branch processes the second subset of input channels 234. The second subset of input channels 234 are down-sampled by a first down-sampling block 206, which applies an average pooling operation with stride=2 along the height and width dimensions of each input channel. In some embodiments, the average pooling operation may be performed by a pooling layer. The average pooling operation generates a set of (Cᵢₙ×(1−α)) down-sampled channels 236, each having height (Hᵢₙ/2) and width (Wᵢₙ/2), and therefore being scaled down in size by a factor of 4 (i.e., N=4 in the illustrated embodiment). In some embodiments, different down-sampling operations may be used, such as max pooling or Gaussian average pooling.

A second input channel grouping block 208 is then used to further group the set of down-sampled channels 236, allocating a first subset of down-sampled channels 238 (corresponding to the second subset of input channels as described above) consisting of the first ((Cᵢₙ×(1−α))×α) down-sampled channels to a second branch for processing and allocating a second subset of down-sampled channels 244 (corresponding to the third subset of input channels as described above) consisting of the remaining (Cᵢₙ×(1−α)²) down-sampled channels to a third branch for processing.

In the second branch, an intermediate-bandwidth convolution sub-block 210 uses a second set of convolution filters 224 to perform a set of convolution operations on the first subset of down-sampled channels 238. The second set of convolution filters 224 consists of a number of convolution kernels equal to (Cₒᵤₜ×4α(1−α)), each convolution kernel having dimensions h×w×(Cᵢₙ×α(1−α)). The number of convolution kernels is (Cₒᵤₜ×Nα(1−α)) in embodiments where N is not equal to 4.

Because the convolution kernels have a depth smaller than those used by the conventional convolution layer 142, the number of weights in each convolution kernel is reduced. Furthermore, the computing power required to perform the convolution operation of a single convolution kernel on the first subset of down-sampled channels 238 is greatly reduced due to the reduced depth of the convolution kernels, the reduced depth of the input channels, and the reduced size of each down-sampled channel. In some embodiments, this may result in reduced overall computation power required to perform the convolution operation and other operations of the entire multi-band convolution layer 200. In addition, the convolution operations performed by the intermediate-bandwidth convolution sub-block 210 may extract features that manifest at lower frequencies than the features extracted by the full-bandwidth convolution sub-block 204, due to the down-sampling of the array elements (e.g., pixels) of the channels processed by the intermediate-bandwidth convolution sub-block 210.

The convolution operations performed by the intermediate-bandwidth convolution sub-block 210 generate a set of down-sampled output channels 240. The set of down-sampled output channels 240 consists of (Cₒᵤₜ×4α(1−α)) output channels, each having height Hₒᵤₜ and width Wont.

A first pixel shuffling block 212 is used to up-sample the set of down-sampled output channels 240 to match the height and width of the first set of output channels 232. The first pixel shuffling block 212 uses a pixel-shuffling technique as described by Wenzhe Shi, Jose Caballero, Ferenc Huszár, Johannes Totz, Andrew P. Aitken, Rob Bishop, Daniel Rueckert, and Zehan Wang in Real-Time Single Image and Video Super-Resolution Using an Efficient Sub-Pixel Convolutional Neural Network, 2016, arXiv:1609.05158, https://arxiv.org/abs/1609.05158. This pixel-shuffling technique generates a single up-sampled channel from each N channels of the set of down-sampled output channels 240. Each up-sampled channel consists of a matrix of pixel clusters, each pixel cluster consisting of one pixel selected from each of the N down-sampled output channels. For example, where N=4 as in the illustrated example, a first up-sampled channel may be generated by, first, generating a first pixel cluster at the top left corner of the up-sampled channel. The first cluster is a square of four pixels, two to a side, laid out in a predetermined order (e.g. raster scan order). The first pixel in the first pixel cluster is the first pixel from the first down-sampled output channel (e.g. the pixel at the top left corner of the channel); the second pixel in the pixel cluster is the first pixel from the second down-sampled output channel; and so on. A second pixel cluster is generated and laid out within the first up-sampled channel relative to the first pixel cluster, e.g. in raster scan order, the second pixel cluster consisting of the second pixel from each of the first 4 down-sampled output channels. The remaining pixels from each of the first 4 down-sampled output channels are used to generate additional pixel clusters making up the rest of the first up-sampled channel. A second up-sampled channel is then generated using the same technique to combine and shuffle pixels from down-sampled output channels 5 to 8 (i.e. N+1 to 2N), and so on.

The pixel-shuffling operation of the first pixel shuffling block 212 thus generates a first set of up-sampled output channels 242 consisting of (Cₒᵤₜ×α(1−α)) channels, each having height Hₒᵤₜ and width Wₒᵤₜ.

The third branch processes the second subset of down-sampled channels 244. A second down-sampling block 214 applies the same down-sampling operation on the second subset of down-sampled channels 244 that the first down-sampling block 206 applies to the second subset of input channels 234. The second subset of down-sampled channels 244 undergo average pooling with stride 2 in the height and width dimensions, generating a set of twice down-sampled channels 246. In some embodiments, the average pooling operation may be performed by a pooling layer. The set of twice down-sampled channels 246 consists of (Cᵢₙ×(1−α)) channels, each having height (Hᵢₙ/4) and width (Wᵢₙ/4).

A low-bandwidth convolution sub-block 216 applies a third set of convolution kernels 226 to the set of twice down-sampled channels 246. The third set of convolution kernels 226 consists of a number of convolution kernels equal to (Cₒᵤₜ×16(1−α)²), each convolution kernel having dimensions h×w×(Cᵢₙ×(1−α)²). The number of convolution kernels is (Cₒᵤₜ×N²(1−α)²) in embodiments where N is not equal to 4.

The convolution operations applied to the set of twice down-sampled channels 246 by the low-bandwidth convolution sub-block 216 generate a set of twice down-sampled output channels 248, consisting of (Cₒᵤₜ×16(1−α)²) channels, each having height (Hₒᵤₜ/4) and width (Wₒᵤₜ/4).

A second pixel-shuffling block 218 applies the same pixel-shuffling technique as the first pixel shuffling block 212, but with a scaling factor of N² (i.e. 16 in this embodiment) instead of N (i.e. 4 in this embodiment), to the set of twice down-sampled output channels 248 to generate a second set of up-sampled output channels 250 consisting of (Cₒᵤₜ×(1−α)²) channels, each having height Hₒᵤₜ and width Wₒᵤₜ. Thus, each pixel cluster used to generate a channel of the second set of up-sampled output channels 250 contains 16 pixels: one pixel selected from each of 16 channels of the set of twice down-sampled output channels 248.

In some embodiments (not shown), the second pixel-shuffling block 218 may only apply pixel-shuffling at scaling factor N to its input, and route its output through the first pixel shuffling block 212. This would result in two passes of up-sampling at scaling factor N, for a total scaling factor of N². This process would mirror the multi-pass down-sampling of the input channels of the third branch as they are processed by the first down-sampling block 206 and second down-sampling block 214 in series.

The first set of output channels 232, the first set of up-sampled output channels 242, and the second set of up-sampled output channels 250 are concatenated together to form an output activation map 148 by a channel concatenation block 220. In some embodiments, the channel concatenation block 220 concatenates the three sets of output channels 232, 242, 250 using the same channel allocation process applied by the input channel grouping blocks 202 and 208: e.g., if the first input splitting block allocates the first (Cᵢₙ×α) input channels to the first branch, then the channel concatenation block 220 generates the output activation map 148 using the first set of output channels 232 (i.e. the output of the first branch) as the first (Cₒᵤₜ×α) output channels of the output activation map 148.

In other embodiments, the channel concatenation block 220 may apply a different channel allocation process for concatenation than the process used for input channel allocation. For example, some embodiments may use a shuffled channel concatenation process described in greater detail below.

As noted above, some embodiments of a multi-bandwidth convolution block may recursively apply one or more of the functions described above with reference to FIG. 2A. FIG. 2B illustrates a second example multi-bandwidth convolution layer 260 in accordance with the present disclosure, showing the use of recursive input channel grouping, recursive down-sampling, and recursive up-sampling. It will be appreciated that other embodiments are possible that employ recursion for any one, two, or three of the functions in question (i.e. input splitting, down-sampling, and up-sampling).

The second example multi-bandwidth convolution layer 260 accomplishes the same end results as the first example multi-bandwidth convolution layer 200, but the functions performed by various functional blocks of the first example multi-bandwidth convolution layer 200 are replaced with recursive versions thereof. The first input channel grouping block 202 and second input channel grouping block 208 are replaced by a recursive input channel grouping block 262. The first down-sampling block 206 and second down-sampling block 214 are replaced by a recursive down-sampling block 264. The first pixel shuffling block 212 and second pixel shuffling block 218 are replaced by a recursive pixel shuffling block 266. The other functional blocks of the second example multi-bandwidth convolution layer 260 are identical in function to those of the first example multi-bandwidth convolution layer 200 and will not be described in detail.

The illustrated second example multi-bandwidth convolution layer 260 is configured with values matching those of the first example multi-bandwidth convolution layer 200: m=3 and N=4.

The recursive operations of the multi-bandwidth convolution layer 260 may be tracked in some embodiments using a counter, index, or similar mechanism for loop or recursion control. In FIG. 2B, an index value i is shown that is incremented to track the progress of the input channels through the various recursion loops. When the input activation map 144 is received by the recursive input channel grouping block 262, the value of i is set to i=1. The recursive input channel grouping block 262 may check the value of i and route its outputs accordingly. For example, if i=m (i.e., m=1), then all input channels of the recursive input channel grouping block 262 would be allocated to the full-bandwidth convolution sub-block 204. This would be equivalent to the conventional convolution layer 142, with no input splitting, down-sampling, or up-sampling. In embodiments having m>1, (i.e., any embodiment implementing the block, sub-blocks, and functions of the multi-bandwidth convolution described herein), the recursive input channel grouping block 262 instead allocates the first subset of channels (proportional in number to α) to a convolution sub-block corresponding to the current value of i. The second subset of channels (proportional in number to (1−α)) is allocated to the recursive down-sampling block 264.

Thus, the input channels of the input activation map 144 are grouped into two subsets of input channels 230, 234 as in first example multi-bandwidth convolution layer 200. The value of i equals 1, indicating that the recursive input channel grouping block 262 provides the first subset of input channels 230 to the full-bandwidth convolution sub-block 204. The recursive input channel grouping block 262 provides the second subset of input channels 234 to the recursive down-sampling block 264.

The recursive down-sampling block 264 applies the same down-sampling operation as the first down-sampling block 206 or the second down-sampling block 214 from FIG. 2A: it applies an average pooling operation with stride 2 to the second subset of input channels 234, thereby generating the set of down-sampled input channels 236.

Following the recursive down-sampling block 264, the value of i is incremented by one. The value of i is checked again at this point. If i<m, the set of down-sampled input channels 236 is provided to the recursive input channel grouping block 262 to undergo a further splitting of the input channels into a first subset proportional in number to α and a second subset of channels proportional in number to (1−α). Thus, at this stage in the operation of the multi-bandwidth convolution layer 260, the value of i is incremented to 1=2, and this incremented value is compared to the value of m (m=3). Because i<m, the set of down-sampled input channels 236 is provided to the recursive input channel grouping block 262.

The recursive input channel grouping block 262 groups the set of down-sampled input channels 236 into the first subset of down-sampled channels 238 (proportional in number to α) and the second subset of down-sampled channels 244 (proportional in number to (1−α)). The recursive input channel grouping block 262 checks the current value of i (i=2) and accordingly allocates the first subset of down-sampled channels 238 to the intermediate-bandwidth convolution sub-block 210. The second subset of down-sampled channels 244 is allocated to the recursive down-sampling block 264 for a further pass of down-sampling.

As in the first example multi-bandwidth convolution layer 200, the intermediate-bandwidth convolution sub-block 210 generates the set of down-sampled output channels 240. A recursive pixel shuffling block 266 applies up-sampling, at scaling factor N, to the set of down-sampled output channels 240 using the same techniques as the first pixel shuffling block 212, thereby generating the first set of up-sampled output channels 242.

The value of i is checked again: if i>2, the output of the recursive pixel shuffling block 266 is provided as input to the recursive pixel shuffling block 266 again for a further pass of up-sampling, and the value of i is decremented by 1. If i<=2, the output of the recursive pixel shuffling block 266 is provided instead to the channel concatenation block 220. In this example iteration, i=2, therefore the output of the recursive pixel shuffling block 266 (i.e., the first set of up-sampled output channels 242) is provided to the channel concatenation block 220.

The operations of the third branch (i.e. the right-most branch in FIG. 2B) are now described. The recursive down-sampling block 264 down-samples the second subset of down-sampled channels 244 again to generate the set of twice down-sampled channels 246. The value of i is incremented to i=3 and compared to m again (i=3, m=3). Because i is not less than m, the set of twice down-sampled channels 246 is provided to the low-bandwidth convolution sub-block 216.

As in the first example multi-bandwidth convolution layer 200, the low-bandwidth convolution sub-block 216 generates the set of twice down-sampled output channels 248. The recursive pixel shuffling block 266 applies up-sampling, at scaling factor N, to the set of twice down-sampled output channels 248. This generates a set of once-up-sampled output channels (not shown) having dimensions identical to the set of down-sampled output channels 240.

The value of i is checked again: in this example iteration, i is currently equal to 3. Because i>2, the output of the recursive pixel shuffling block 266 is provided as input to the recursive pixel shuffling block 266 again for a further pass of up-sampling, and the value of i is decremented by 1 (i=2). The recursive pixel shuffling block 266 applies up-sampling a second time, at scaling factor N, to its own previous output, generating the second set of up-sampled output channels 250.

The value of i is checked again: in this example iteration, i is currently equal to 2. Because i<=2, the output of the recursive pixel shuffling block 266 (i.e., the second set of up-sampled output channels 250) is provided to the channel concatenation block 220.

The channel concatenation block 220 concatenates the first set of output channels 232, the first set of up-sampled output channels 242, and the second set of up-sampled output channels 250 to form the output activation map 148, as described above with reference to FIG. 2A.

FIG. 2C shows a method 270 for operating the second example multi-bandwidth convolution layer of FIG. 2B. At 272, the input activation map 144 is received by the recursive input channel grouping block 262, which performs the first split into branches i and i+1 (initially, branches i=1 and i=2). At 274, the input channels of branch i+1 (initially i=2, meaning the input channels are the second subset of input channels 234) are down-sampled by the recursive down-sampling block 264. The value of i is incremented, and the recursive splitting operation at 272 and recursive down-sampling operation of 274 are repeated for subsequent splits until i=m.

At 276, the convolution operations of branch i are then applied to the input channels of that branch (initially, i=m, indicating the lowest-bandwidth branch, so the low-bandwidth convolution sub-block 216 in an embodiment with m=3). If i>1, the method 270 proceeds to step 278, otherwise it proceeds to step 282.

At 278, the outputs channels of branch i are up-sampled by the recursive pixel shuffling block 266 a total of (i−1) times. At 280, the up-sampled channels from branch i are provided to the channel concatenation block 220. The value of i is decremented, and the method 270 returns to step 276 to process the next-highest-bandwidth branch (i=m−1, then i=m−2, etc.).

At 282, the value of i has been confirmed to be equal to 1, meaning that the full-bandwidth convolution sub-block 204 has completed its convolution operation. The output of the convolution operations of branch i=1 (i.e., the first set of output channels 232) are provided to the channel concatenation block 220.

At 284, the channel concatenation block 220 concatenates together all of its inputs.

A CNN including one or more example multi-bandwidth convolution layers described herein is trained in a training mode (also called training) before being deployed for inference (i.e. prediction) to perform the task in an inference mode. Example embodiments described herein use supervised learning during training of a CNN including one or more of the multi-bandwidth convolution layers. During training, labelled training data is forward-propagated through the layers of the CNN, including the one or more multi-bandwidth convolution layers, following the process described above. The weights of the various convolution kernels 222, 224, 226 are adjusted based on a loss of the CNN computed using a loss function applied to the output of the CNN and the label of the training data. The loss computed is then back-propagated through the layers of the CNN, including one or more of the multi-bandwidth convolution layers to update the weights of the CNN, including the weights of the convolutional kernels of the multi-bandwidth convolution layer. Thus, during training, a loss is computed based on the output of the CNN (which is a function of the output activation map of the convolution layer), and the weights of the various convolution kernels 222, 224, 226 are adjusted based on that computed loss. The operations of input channel grouping, down-sampling (consisting of average pooling and stride), pixel shuffling and channel concatenation are all differentiable, so the entire operation in FIG. 2B is end-to-end differentiable. Thus, computed loss at the output of the CNN can be back-propagated through the layers of the CNN, including the one or more multi-bandwidth convolution layers using the chain rule of differentiation, as is commonly used in training of a CNN.

It will be appreciated that embodiments of the multi-bandwidth convolution layer having m>3 will have multiple intermediate-bandwidth convolution sub-blocks, each having a progressively lower bandwidth. These may be referred to as a first intermediate-bandwidth convolution sub-block (in the second branch), a second intermediate-bandwidth convolution sub-block (in the third branch), and so on. The low-bandwidth convolution sub-block may be referred to as a final convolution sub-block. Similarly, the branches of the multi-bandwidth convolution sub-block may be referred to as a first branch (1=1), a first intermediate branch or second branch (i=2), a second intermediate branch or third branch (i=3), and so on until a final branch (i=m).

Whereas the multi-bandwidth convolution layers described herein include multiple branches whose inputs channels are allocated thereto by an input channel grouping block, it will be appreciated that other embodiments may use different specific mechanisms to receive a set of input channels and perform two or more convolution operations at different respective bandwidths on respective subsets of the input channels before re-combining the convolution outputs after scaling them to the same bandwidth.

Frequency Band Attention Function

In various examples, the present disclosure also describes identifying important weights of the convolutional kernels within the multi-bandwidth convolution layer 200 or 260, based on particular characteristics, including the magnitude of a weight of the convolution kernel, and the location of a weight in the convolution kernel. On the basis that some weights are more important than other weights, the present disclosure also describes example methods to focus on or provide attention to the more important weights during training. After a CNN that includes one or more of the multi-bandwidth convolution layers 200 or 260 has been trained for a specific task and the appropriate weights of the CNN have been learned (including the weights of the one or more of the multi-bandwidth convolution layers 200 or 260), the learned weights of the CNN may be fixed and the trained CNN that includes the one or more of the multi-bandwidth convolution layers 200 or 260 may be deployed to perform the specific task for which the CNN has been trained for.

As will be discussed further below, examples disclosed herein may be used together with existing approaches that apply attention to output channels generated by the convolution operation (e.g., as used in Squeeze-and-Excitation blocks or networks).

Existing methods of training a convolutional neural network have not attempted to identify important weights of the convolutional kernels during training of the convolutional neural network, and have not attempted to focus training of the convolutional neural network on reducing misplacement (or mis-learning) of more important weights of the convolutional kernels of the convolution blocks of the convolutional neural network.

Some existing approaches (e.g., see Siyuan Qiao et al., 2019; Tim Salimans et al., 2016; and Takeru Miyato et al, 2018) include weight reparameterization techniques that are aimed at making the optimization of the weights of the neural network easier and more stable. For example, weight standardization reparameterizes weights in a way that the Lipschitz constant of the loss and the gradients get reduced resulting in a smoother loss landscape and a more stable optimization. With a more stable optimization process, weight values are less likely to be misplaced severely and the convolution block is trained to some good minima. However, such methods do not attempt to identify important weights or focus on reducing misplacement of the important weights.

In some examples, the disclosed methods and systems for identifying important weights may be used to provide improved weight reparameterization to improve the feature extraction performed by multi-bandwidth convolution layers.

Another existing approach involves attention mechanisms that learn to provide attention to particular parts of the activation maps in a CNN (e.g., see Jie Hu et al, 2018; Irwa Bello et al, 2019; Jongchan Park et al, 2018; Sanghuyn Woo et al., 2018). Such activation-based attention learning methods typically do not have much control on providing focus to a particular weight of a of the network—for example, in “Squeeze-and-Excitation” networks, an excited activation map channel leads to attention being provided to all the weights of the network that contributed to generating that activation map channel. Additionally, such activation-attention providing methods typically require additional feature memory, extra computation cost and/or changes to a network architecture during runtime.

In various examples, the present disclosure describes mechanisms for providing attention to weights of the set of the convolution kernels of the multi-bandwidth convolution layer (also referred to as “weight excitation”) that directly target weights of the set of convolutional kernels that are more likely to be important during training of a convolutional neural network that includes a convolution block with one or more multi-bandwidth layers. Little or no additional computation cost may be required at runtime. Furthermore, the attention mechanisms described herein may be added to aconvolution layer of a conventional convolutional block of a convolutional neural network relatively easily, by modifying the convolution operation or the convolution block of the convolutional neural network. The described attention mechanisms may be included within the described multi-bandwidth convolution layer to increase performance of a convolutional neural network that includes one or more of the described multi-bandwidth convolution blocks.

In the present disclosure, the term “weight excitation” may be used to refer to the process of giving more attention to or emphasizing the learning of a weight, during the training of a convolutional neural network that includes one or more of the multi-bandwidth convolution blocks. A “weight excitation mechanism” may be any mechanism that is designed to give more attention to (or excite) a weight. In some contexts, “attention” and “attention mechanism” may be terms that could be used instead of “excitation” and “excitation mechanism”.

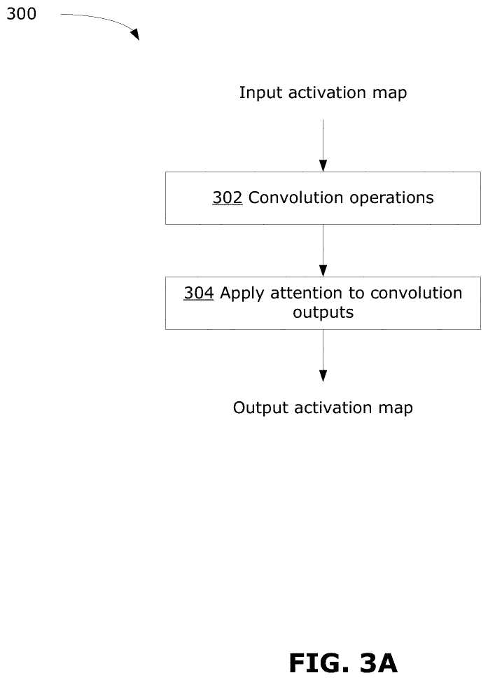

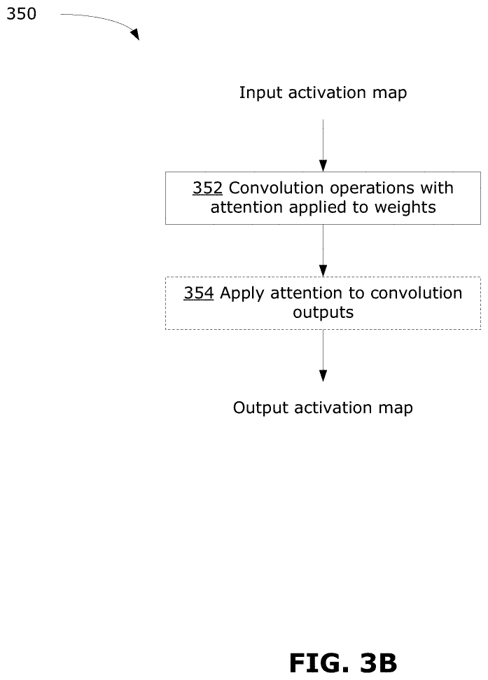

FIG. 3A is a flowchart that illustrates an example method 300 that may be used for performing operations during the training of a Squeeze-and-Excitation neural network (i.e. a neural network known in the art as a “Squeeze-and-Excitation” neural network). The method 300 is a simplification of the operations performed by the Squeeze-and-Excitation neural network, in which attention is applied to weights after convolution operations are performed by a conventional convolutional layer. A block containing one or more convolution layers and a fully-connected layer for applying attention to weights may be referred to as a Squeeze-and-Excitation block. Generally, an input activation map is received by the conventional convolution layer in a Squeeze-and-Excitation block. At 302, convolution operations are performed on the input activation map using a set of convolution kernels. The weights of the set of convolution kernels have been learned, without focusing attention on specific more important weights in the set of convolution kernels. The convolution operations are performed on a first number of input channels of the input activation map to generate a second number of output channels. At 304, attention is applied to the outputs generated by the convolution operations. In the Squeeze-and-Excitation block, attention is applied by applying different weights to the output channels of a fully connected layer of the Squeeze-and-Excitation block using a channel-based attention function, thus scaling each output channel based on its relative importance compared to each other output channel. Notably, attention is not applied directly to the weights of the set convolution kernels in the convolution layer.

FIG. 3B is a flowchart that illustrates an example method 350 for performing operations of a multi-bandwidth convolution block of a convolutional neural network using built-in attention, in accordance with the present disclosure. In contrast to the method 300 described above, the present disclosure enables operations of the multi-bandwidth convolution block of a convolutional network to be performed with applying attention directly to the weights of the set of convolution kernels in the multi-bandwidth convolution block.

Similar to the method 300, the multi-bandwidth convolution layer may be a layer in any convolution block of a CNN, and the input activation map 144 that is inputted into the multi-bandwidth convolution layer may be, for example, the output of a previous layer (e.g., a preprocessing layer, convolution layer, pooling layer, etc.) of a convolution block. For example, the previous layer of a convolution block may be multi-bandwidth convolution layer 200 or 260 or a conventional convolutional layer 142.

At 352, convolution operations are performed using convolution kernels with built-in attention. Because the attention is applied to weights of the convolution kernels (as opposed to being applied to the output of the convolution layer), this approach may be referred to as “built-in” attention. In the present disclosure, different mechanisms (described in greater detail below) are described to enable more attention to be applied to weights of the convolution kernels of the multi-bandwidth convolution layer that are considered to be more important. A more important weight in the convolution kernels is a weight that is expected to contribute more to the performance of the multi-bandwidth convolution layer and hence a weight that should be more optimized during training of a CNN than includes the multi-bandwidth convolution layer. Conversely, a less important weight in the convolution kernels of the multi-bandwidth convolution layer is a weight that is expected to have less contribution to the performance of the CNN that includes the multi-bandwidth convolution layer and hence does not have to be as well-learned.

At 354, optionally, attention may also be applied to the output channels generated by the convolution operations. The attention that is applied at 354 may be applied using a channel-based attention mechanism, similar to the attention applied at 304 above. Thus, the built-in attention described in the present disclosure may be used together with and complementary with existing approaches to attention-based learning that applies attention to the outputs generated by the convolution operations of the multi-bandwidth convolution block.

The resulting output activation map may then be used by the classification head of the CNN to generate an inference, compute a loss using a loss function applied to the generated inference, and perform backpropagation using the computed loss to update the weights of the layers of the CNN, including the weights of the set of convolution kernels of the multi-bandwidth convolution layer, using various suitable techniques for optimizing the weights of a set of convolution kernels, such as gradient descent or gradient ascent. Notably, because attention has been applied directly to the more important weights of the set of convolution kernels of the multi-bandwidth convolution layer, the loss computed using the loss function and the backpropagation will be more focused on updating and optimizing those more important weights of the set of convolution kernels of the multi-bandwidth convolution layer.

After the CNN that includes one or more of the multi-bandwidth convolution layers has been trained and the weights learned to achieve a desired degree of accuracy for the CNN, the trained CNN may be used to perform the specific task for which it has been trained during inference.

A weight of a convolution kernel may be considered to be a more important weight (compared to other weights in the set of convolution kernels) based on its magnitude. Generally, a baseline convolution operation in the multi-bandwidth convolution block can be represented as:

yᵢ=Wᵢ [symbol] x

where yᵢ is the ith output channel of the multi-bandwidth convolution layer, x is the input (e.g., 1D, 2D or 3D (or higher dimension) input activation map), [symbol] is the convolution operator and Wᵢ is the ith convolution kernel. Wᵢ has a dimension of In×h×w, where In is the number of input channels, and h and w are the height and width respectively of the convolution kernel. Assuming x is non-zero, it has been found that zeroing the largest magnitude weight of Wᵢ will result in a larger change in yᵢ (mathematically denoted as ∇y₁) than if the smallest magnitude weight of Wᵢ is zeroed. This indicates that higher magnitude weights contribute more to outputs generated by the convolution operation. Accordingly, higher magnitude weights of Wᵢ are likely to have a greater effect on the performance (e.g., accuracy) of a trained CNN that includes one or more of the multi-bandwidth convolution layers than lower magnitude weights of Wᵢ. Thus, higher magnitude weights of Wᵢ are considered to be more important than lower magnitude weights of Wᵢ.

Another characteristic that may lead to a weight of Wᵢ being considered to be more important is the frequency band to which the weight Wᵢ is applied. In the context of a multi-bandwidth convolution layer 200 or 260 described with reference to FIGS. 2A and 2B above, each branch of the multi-bandwidth convolution layer 200, 260 effectively performs convolution operations at a different frequency band due to the down-sampling of the input channels. Thus, attention may be focused on weights that extract features at specific bandwidths or within specific frequency bands, if those features are likely to have a greater effect on the performance of the trained convolutional neural network that includes one or more of the multi-bandwidth convolution layers 200, 260.

Because the importance of a weight of Wᵢ is dependent on its magnitude and frequency characteristics, the present disclosure describes weight excitation mechanisms based on each of these two characteristics. One weight excitation mechanism is referred to herein as frequency-based weight excitation (FWE), and another weight excitation mechanism is referred to herein as magnitude-based weight excitation (MWE). Generally, to excite an important weight wⱼ of Wᵢ, a relatively larger magnitude gain Gⱼ is applied to the weight wⱼ of Wᵢ, compared to the magnitude gain provided to other weights of Wᵢ. Because the gradients for the weight wⱼ also are affected by a gain of Gⱼ, the result is that more attention is provided towards properly optimizing the weight wⱼ.

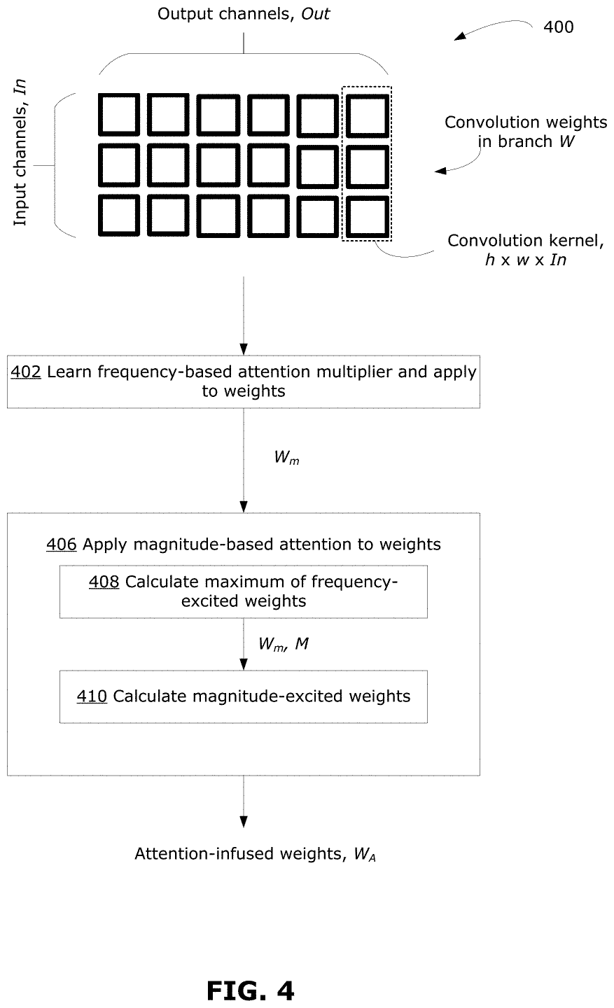

FIG. 4 is a flowchart illustrating an example method 400 for applying frequency-based and magnitude-based attention to weights of Wᵢ, during training of a convolutional neural network that includes one or more multi-bandwidth convolution layers 200, 260. Because the attention is applied to weights of Wᵢ of the multi-bandwidth convolution layers 200, 260 (as opposed to being applied to the output channels of the multi-bandwidth convolution layer 200, 260), this approach may be referred to as “built-in” attention.

The input is a 4D weight tensor (W(Out,In,h,w)) of a branch of a multi-band convolutional layer 200, 260. It should be understood that the dimensionality may be different depending on the dimensionality of the input to the branch of the multi-band convolutional layer 200, 260: for example, the values of In and Out for the first branch (i=1) of the multi-band convolution layer 260 of FIG. 2B are equal to, respectively the number of input channels in the first subset of inputs channels 230 provided as input to the full-bandwidth convolution block 204 (i.e. In=αCᵢₙ), and the number of output channels in the first set of output channels 232 generated as the output of the full-bandwidth convolution block 204 (i.e. Out=αCₒᵤₜ). In some examples, the weights W may be standardized across each ith channel, similar to standardizing an input before being fed into a convolution block. The standardization may be calculated as:

W_{n,i}=(Wᵢ−μᵢ)/σᵢ

where W_{n,i} is the normalized weights of the ith output channel, μᵢ and σᵢ are the mean and standard deviation, respectively, of the weights in the ith output channel. The result of standardization is a standardized mean of zero and a standardized deviation of 1. Such standardization may be performed to help simplify learning of the convolution block.

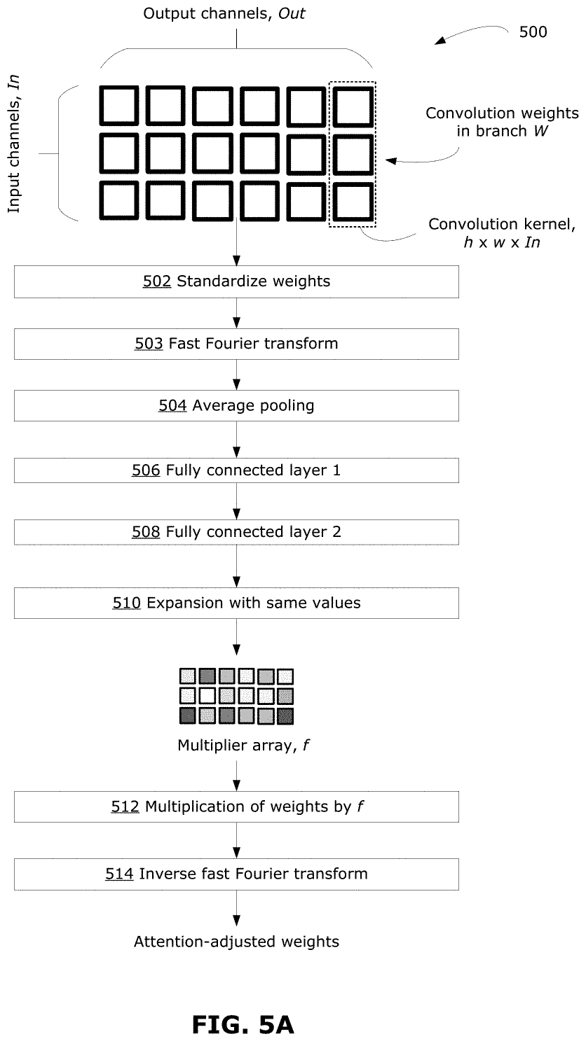

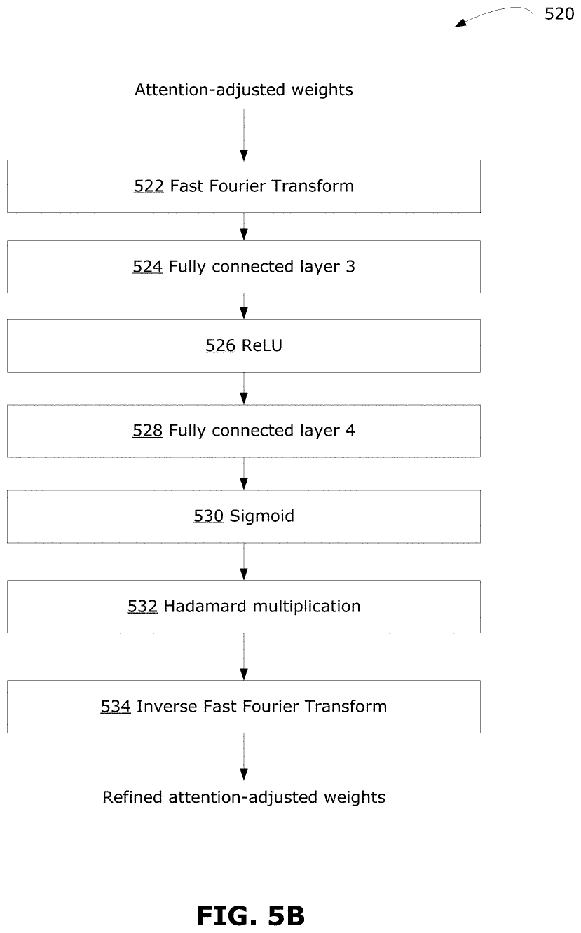

At 402, the frequency-based attention multiplier ƒ is learned and then applied to the weights. Details of the sub-network for learning the frequency-based attention multiplier ƒ will be discussed with reference to FIG. 5. The frequency-based attention multiplier ƒ in this example is an array of different multiplier values that are applied in the frequency domain to respective convolution kernels in the convolution layer. The size of the frequency-based attention multiplier ƒ is an array of dimension Out×In. Generally, the higher the magnitude of the multiplier, the greater the attention applied to the weight.

At 406, magnitude-based attention is applied to the frequency-excited weights Wₘ. The magnitude-based weight excitation mechanism provides more attention to weights having higher magnitudes. This involves steps 408 and 410.

At 408, the maximum M of the frequency-excited weights is calculated.

At 410, the magnitude-excited weights are calculated. An attention function is used for this magnitude-based excitation, discussed further below.

The result of the frequency-based and magnitude-based excitation is a set of attention-infused weights W_{A}, in which the more important weights (as determined based on frequency and magnitude characteristics) have been more excited compared to less important weights. The attention-infused weights W_{A} are used in the convolution operations during training of the CNN, as discussed above with respect to FIG. 3B.

It should be noted that the frequency-based and magnitude-based weight excitation mechanisms may be only applied during training. After the CNN has been trained, the frequency-based and magnitude-based weight excitation mechanisms may no longer be used. The disclosed weight excitation mechanisms are not required when the trained CNN is deployed for inference (i.e. prediction).

This may result in little or no additional computation cost, memory usage and structural changes in the overall architecture of the CNN.

Details of how the frequency-based attention multiplier is learned are now discussed with reference to FIG. 5A. The method 500 of FIG. 5A may be used at step 402 discussed above. Compared to the method 300 described above, the frequency-based weight excitation mechanism described here results in attention being applied directly to the weights themselves, rather than attention being applied to the convolution outputs.

The general operation of the method 500 may be represented as

mᵢ=FC₂(FC₁(Avg(W_{n,i}))) (1)

At 502 the weights are standardized, as described above, to obtain the standardized weights W_{n,i}.

At 503, a multi-dimensional fast Fourier transform (FFT) operation is applied to the weights. This transforms the weight values from the spatio-temporal domain to the frequency domain. The FFT operation generates a tensor of the same dimensions as the input tensor.

At 504, the average pooling operation Avg is performed. Average pooling is an operation that averages every h×w kernel to one averaged value, resulting in a In-sized tensor. The average pooling operation may be performed as a form of dimension reduction. This may help to reduce the number of computations, to help improve computing efficient and help simplify learning of the CNN. Other types of dimension reduction operations may be performed instead.

At 506 and 508, the averaged weights are feed into fully connected layers FC₁ and FC₂, resulting in another In-sized tensor. The use of the fully connected layers enable learning of the relative importance of each convolution kernel. The In-sized tensor thus may be used as an attention multiplier for the In convolution kernels.

It may be noted that FC₁ and FC₂ for all the outputs of a convolutional layer have shared weights, and that Avg averages over w for a 1D convolution and over t×h×w in a 3D convolution.

Although two fully connected layers are illustrated in FIG. 5A, in some examples there may be one fully connected layer, or three (or more) fully connected layers instead. Furthermore, in some examples, there may be an activation layer following the fully connected layer(s). This activation layer may apply a sigmoid, a rectified linear unit, leaky rectified linear unit function, or any other suitable activation function. The activation layer following the fully connected layer(s) may be used for normalizing or regularizing the attention multiplier that will be used for the frequency-based weight excitation mechanism. Generally, the use of two fully connected layers (with or without a following activation function) may be common for learning classification tasks, and may enable the learning of more complex (e.g., non-linear) relationships among channels.

At 510, the In-sized tensors of each output channel are expanded by value replication to a In×h×w sized tensor h, to form the multiplier array ƒ.

It may be noted that the above-described process (represented by equation (1)) is performed for each output channel W_{n,i}, ultimately generating In different attention multipliers h.

At 512, the frequency-based attention multiplier array ƒ is applied to the weights. Each multiplier ƒᵢ in the multiplier array is independently applied to the normalized weights of each channel W_{n,i}. In this example, the multiplier may be applied using Hadamard multiplication, such that

W_{ƒ,i}=(W_{n,i}∘ƒᵢ)

where ∘ represents the Hadamard multiplication, and W_{ƒ,i} is the weights of the ith output channel after application of the frequency-based attention multiplier. For simplicity, W_{ƒ,i} may also be referred to as the frequency-excited weights.

As will be discussed further below, the frequency-based attention multiplier may apply independent multipliers for each convolution kernel. The rationale for independent multipliers ƒᵢ being applied to respective convolution kernels is that each of these kernels is applied to different frequency bands of the input channels with varying importance in its weights and thus deserve varying levels of attention.

At 514, an inverse of the fast Fourier transform of step 503 is applied to the weights. This transforms the weight values from the frequency domain back to their original spatio-temporal domain.

In the context of a multi-bandwidth convolution layer such as 200 or 260, method 500 is applied separately to each set of kernels, i.e. for multi-band convolution layer 200 having m=3, method 500 is applied three separate times: to the first set of convolution filters 222, to the second set of convolution filters 224, and to the third set of convolution filters 226.

In some embodiments, the frequency-based attention function is further refined after the completion of method 500 by a second frequency-based attention method 520 shown in FIG. 5B. Method 520 is applied to each channel of each kernel separately (i.e., to each h×w slice of each kernel). Thus, the attention-adjusted weights in the spatio-temporal domain generated by the inverse of the fast Fourier transform at step 514 are split into In slices each of size h×w, and each slice is an input to method 520.

At 522, the slice of kernel weights undergoes another fast Fourier transform function to transform it back to the frequency domain, resulting in a frequency-domain slice of the same dimensions as the input, i.e. h×w, or simply h×w.

At 524, the frequency-domain weights are fed into fully connected layer FC₃, resulting in a tensor of dimensions (h×w)².

At 526, a rectified linear activation function is applied to the output tensor of layer FC₃ by a rectified linear unit (ReLU).

At 528, the output of the ReLU is provided to fully connected layer FC₄, the output of which has a dimension of h×w.

At 530, a sigmoid function is applied to the output tensor of layer FC₄, generating a further tensor of dimensions h×w: this tensor is used as the multiplier array ƒ₂.

As described in step 506 and 508 of method 500, the example method 520 uses two fully-connected layers. In method 520, the two fully-connected layers have a ReLU function between them and a sigmoid function following the second fully-connected layer. However, in some examples there may be one fully connected layer, or three (or more) fully connected layers instead. Furthermore some embodiments may omit or vary the ReLU and/or sigmoid activation function following the fully connected layer(s). These functions may in some embodiments be sigmoid functions, ReLU functions, leaky ReLU functions, or any other suitable activation functions, depending on the inference task performed by the neural network including the convolution block.

At 532, the frequency-based attention multiplier array ƒ₂ is elementwise multiplied or Hadamard multiplied to the input weights to the method 520 (i.e., the attention-adjusted weight at the top of FIG. 5B). Note that the dimensions of the attention-adjusted kernel weights of FIG. 5B are the same for each slice (i.e. h×w), so for all In and Out channels, the input dimension of method 520 and the output dimension of step 530 is the same, i.e. Out×In×h×w, enabling the elementwise multiplication at 532.

At 534, the weights are transformed back to the spatio-temporal domain by applying a reverse fast Fourier transform, as in step 514 of method 500. This transformation generates a set of refined attention-adjusted weights.

By undergoing a further refinement of frequency-based attention using method 520, some embodiments of the multi-bandwidth convolution layer may produce more accurate results when extracting features at different bandwidths.

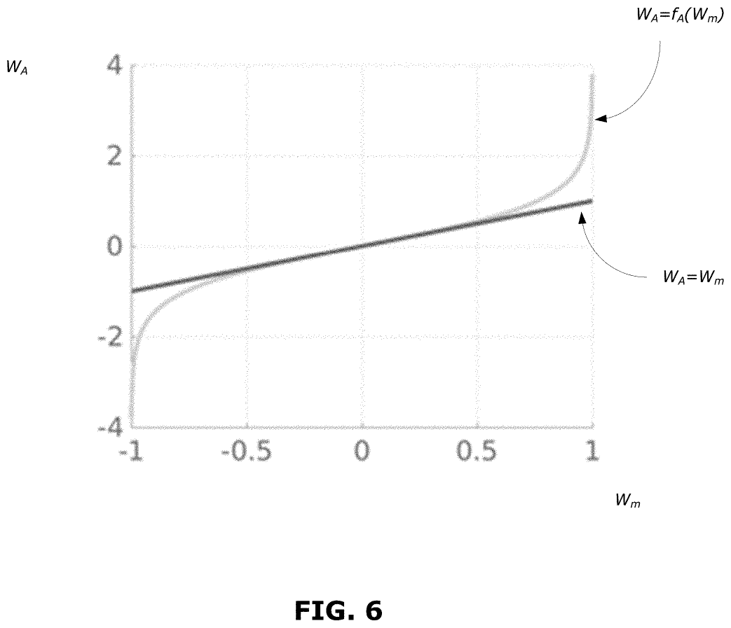

FIG. 6 is a plot of an example magnitude-based attention function ƒ_{A}(wₘ) that may be used to apply magnitude-based attention. In some contexts, the magnitude-based attention function ƒ_{A}(wₘ) may also be referred to as an activation function. The attention function takes in individual weight values wₘ and provides relatively higher gains G to weights having relatively larger magnitudes than others. In this example, the attention function is

$${W}_{A} = {f}_{A} ( {w}_{m} ) = {M}_{A} * 0.5 * ln \frac{1 + {w}_{m} / {M}_{A}}{1 - {w}_{m} / {M}_{A}} \qquad ( 2 )$$

where M_{A}=(1+ϵ_{A})*M, M is the maximum of all wₘ in the multi-bandwidth convolution layer and ϵ_{A} is a hyperparameter with a small value (0<ϵ_{A}<0.2). For smaller values of wₘ (i.e., smaller magnitude weights), the attention function ƒ_{A} approximates to an identity line (i.e., w_{A}=wₘ). Because the gradient of an identity line is 1, the backward propagated gradients for small values of wₘ (∇wₘ) are not affected after applying ƒ_{A}. For larger values of wₘ (i.e., larger magnitude weights), gradient gains progressively increase while remaining bounded due to normalization of wₘ by M_{A} (see equation (2)).

Other attention functions may be used (e.g., w_{A}=wₘ+wₘ³, etc.). Generally, the attention function ƒ_{A}(wₘ) should provide higher magnitude gains for larger wₘ values, should be differentiable, and avoid vanishing and exploding gradient problems.

In the present disclosure, weight excitation may be performed using a frequency-based weight excitation mechanism and a magnitude-based weight excitation mechanism. The two excitation mechanisms may be used independently and separately. For example, in the context of FIG. 4, the steps 402 and 404 may be omitted, to obtain attention-infused weights using the magnitude-based weight excitation mechanism only. Conversely, the steps 406-410 may be omitted, to obtain attention-infused weights using the frequency-based weight excitation mechanism only. Variations of the method 400 have been considered in example studies, which found that frequency-based weight excitation may have a greater effect on accuracy improvement, compared with magnitude-based weight excitation. However, because the frequency-based weight excitation mechanism may be calculated on a per-channel basis, the additional use of magnitude-based weight excitation may be useful for shift-based convolutions.

In various examples, a method of training a CNN using built-in attention, applied directly to the weights of the kernels of one or more of the convolution layers of the CNN, is described. This method has been found to achieve improvement in performance (e.g., accuracy) of the CNN in performing a specific task during inference. At the same time, there is little or no increase in computational effort during inference, because the mechanisms for applying attention to the weights are not needed during inference.

Additionally, since a fully connected layer in a CNN can also be represented as a convolution operation, the built-in attention mechanism disclosed herein can also be applied in various other applications wherein a fully connected layer is used.

Shuffled Concatenation of Output Channels

In some embodiments, the channel concatenation block 220 of the multi-bandwidth convolution layer 200 or 260 may be a shuffled concatenation block using a shuffled concatenation method in order to more effectively learn to generate inferences based on features obtained from all low-bandwidth to high-bandwidth branches of the multi-bandwidth convolution layer. By using shuffled concatenation, the output activation map 148 generated for processing by the next convolution block can mix low-frequency to high-frequency features extracted by the multi-bandwidth convolution layer. The rationale for mixing low and high frequency features is that most visual understanding is usually based on a wide range of frequency features (e.g. recognizing a cat would require understanding high frequency features such as whiskers and low frequency features such as skin texture).

The shuffling concatenation can be broken down to two basic operations—concatenation and shuffling.

Concatenation concatenates output channels from the different branches. For example, for m=2, with 6 output channels generated by a high bandwidth branch and 2 output channels generated by a low bandwidth branch, concatenating the output channels results in 8 channels. However, with a basic concatenation, the high bandwidth and low bandwidth channels remain clustered and separated.

Shuffling breaks the clustered separation of high and low bandwidth branches. For the above example, assuming high bandwidth branch has output channels A1, A2, A3, A4, A5, A6 and low bandwidth branch has output channels B1, B2, a simple concatenation results in concatenated output channels in order A1, A2, A3, A4, A5, A6, B1, B2. Shuffling is done in a skip-by-two pattern such that the above channels are shuffled as A1, A3, A5, B1, A2, A4, A6, B2.

This also works for m>2, i.e. more than two branches. In an example implementation where a highest bandwidth branch contributes to 4 output channels (A1, A2, A3, A4), a second highest bandwidth branch contributes to 2 output channels (B1, B2), and a lowest bandwidth branch contributes to 2 output channels (C1, C2), the concatenated output channels are shuffled from (A1, A2, A3, A4, B1, B2, C1, C2) to (A1, A3, B1, C1, A2, A4, B2, C2)

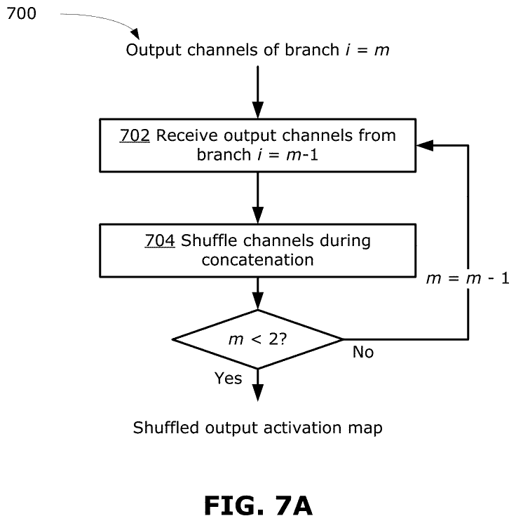

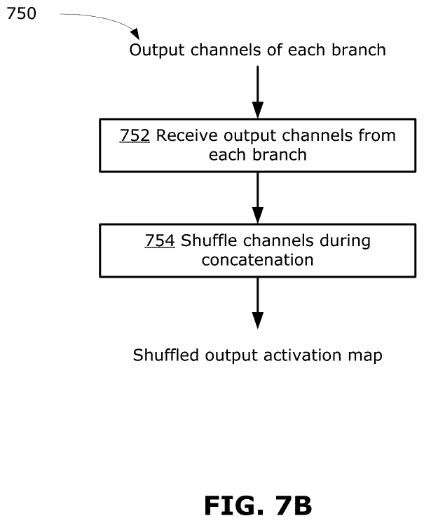

FIG. 7A shows a method 700 for recursive shuffled concatenation of output channels from multiple branches of a multi-bandwidth convolution block to form a shuffled output activation map. The method 700 begins with the output channels from the lowest-bandwidth branch of the multi-band convolution block (i=m). At 702, the output channels from the next lowest-bandwidth branch (i=m−1) are received. The two lowest-bandwidth branches are the branches corresponding to i=m and i=m-1 in the second example multi-bandwidth convolution layer 260 described above and shown in FIG. 2B. In the described example of the operation of the multi-bandwidth convolution layer 260 wherein m=3, this means the second set of up-sampled output channels 250 (generated by the right most branch labelled “i=3”) and the first set of up-sampled output channels 242 (generated by the middle branch labelled “i=2”).

At 704, the channels of the two sets of output channels are concatenated together using a shuffling pattern instead of simply appending the second set of channels after the first set of channels. In some embodiments, this shuffling pattern is a skip-by-two pattern wherein each set of N channels received in order as channels 1, 2, 3, . . . N are concatenated together in order 1, 4, 7, . . . 2, 5, 8, . . . 3, 6, 9, . . . etc. In other embodiments, the shuffling pattern may be a skip-by-one pattern (odd-numbered channels followed by even-numbered channels), skip-by-S wherein S is any positive integer, or some other shuffling pattern that mixes the clustered output channels of multiple branches together.

Thus, in the example described above with reference to FIG. 2B, assuming that Cₒᵤₜ=128 and α=0.875, the first set of output channels 232 would consist of 112 channels (numbered 1 to 112), the first set of up-sampled output channels 242 would consist of 14 channels (numbered 113 to 126), and the second set of up-sampled output channels 250 would consist of 2 channels (numbered 127 and 128). At the first iteration of steps 702 and 704, output channels numbered 113 to 126 and 127 to 128 would be received at step 702, and at step 704 they would be shuffled using a skip-by-two shuffling pattern and concatenated into an order of channels numbered (113, 116, 119, 122, 125, 128, 114, 117, 120, 123, 126, 115, 118, 121, 124, 127).

Other embodiments may use different shuffling patterns at step 704.

After step 704, the value of m is checked. If m<2, the last branch (i.e. the left-most branch marked i=1 in FIG. 2B) has been processed, and the results of the concatenation steps so far are provided as a shuffled output activation map (in place of output activation map 148). If m>=2, the value of m is decremented by one, and the method 520 returns to step 702 to concatenate the output channels of the next higher-bandwidth branch with those already concatenated in the previous iteration of steps 702 and 704. In the presently-described example iteration, this would mean receiving the output channels of right-most branch (i=1), i.e. the first set of 112 output channels 232, and shuffling and concatenating them at step 704 with the previous set of shuffled and concatenated channels. This would result in output channels numbered 1, 4, 7, . . . 112, 119, 128, 120, 115, 124, 2, 5, . . . and so on.

FIG. 7B shows a method 750 for non-recursive shuffled concatenation of output channels from multiple branches of a multi-bandwidth convolution block to form a shuffled output activation map. At 752, the channel concatenation block receives the output channels from each branch of the multi-bandwidth convolution block. At 754, the multiple sets of output channels are concatenated together in accordance with the examples above, e.g., the output channels of a first branch A1, A2, A3, A4, A5, A6, the output channels of a second branch B1, B2, and the output channels of a third branch C1, C2 are shuffled from (A1, A2, A3, A4, B1, B2, C1, C2) to (A1, A3, B1, C1, A2, A4, B2, C2) using a skip-by-two shuffling pattern. As in method 700 above, different shuffling patterns may be used in different embodiments.

By using shuffled concatenation, features generated from low- to high-bandwidth pathways may be combined in some embodiments. This may allow subsequent convolution operations in later layers of the neural network to learn from features having different bandwidths. The low bandwidth pathways will tend to be rich in high receptive field, whereas the high bandwidth pathways will tend to be rich in high resolution features. Combining both together in learning may allow them to complement one another, potentially improving the performance of the neural network.

In some embodiments, the 2D multi-bandwidth separated 2D convolution performed by the multi-bandwidth convolution layers 200, 260 described above may be extended to 3D using a shuffled concatenation technique in conjunction with the temporally shifted 3D convolution operation proposed by Lin J, Gan C, and Han S. in Temporal shift module for efficient video understanding, arXiv:1811.08383, 2018 Nov. 20, https://arxiv.org/pdf/1811.08383.pdf (hereinafter “Lin”), which is hereby incorporated by reference in its entirety.

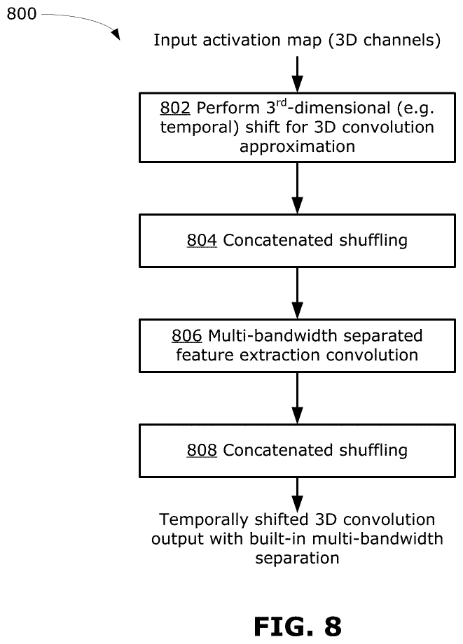

FIG. 8 shows an example method 800 for multi-bandwidth separated 3D convolution using a 3D multi-bandwidth separated feature extraction convolution block employing shuffled concatenation both before and after the convolution operations.

At 802, an input activation map consisting of a plurality of 3D data channels (such as sets of 2D video frames arranged along a 3rd temporal dimension) undergoes a 3rd-dimensional shift for 3D convolution approximation, as described in Lin, supra. In some embodiments, this entails using a temporal shift module (TSM) to shift some of the input channels along the temporal dimension, thus facilitating information exchange among neighboring temporal slices (e.g. video frames) of the input data. However, some embodiments may perform 3rd-dimensional shifting wherein the various dimensions of each channel are other than height, width, and time.

At 804, a concatenated shuffling operation is applied to the shifted input channels, as described at step 754 of method 750 above.

At 806, a 3D version of the multi-bandwidth convolution operation is applied, analogous to the examples described above with reference to FIG. 2A-2B. The 3D convolution operation described in Lin, supra may be used in place of the 2D convolution operations applied by the convolution sub-blocks 204, 210, 216 of the example multi-bandwidth convolution layers 200, 260. Otherwise, this step 806 corresponds to the entire series of operations of the multi-bandwidth convolution layer 200 or 260.

At 808, a second concatenated shuffling operation is applied to the output channels of the multi-bandwidth convolution block, as described at step 754 of method 750 above.

The output of the second shuffled concatenation operation is a temporally (or otherwise 3rd-dimensionally) shifted 3D convolution output with built-in multi-bandwidth separation. When extended to 3D convolution, low-bandwidth spatial features, low-bandwidth temporal features, high-bandwidth-spatial features and high-bandwidth temporal features may all be extracted and combined. A similar approach is taken by the SlowFast network described by Feichtenhofer C, Fan H, Malik J, and He K. in Slowfast networks for video recognition, arXiv:1812.03982, 2018 Dec. 10, https://arxiv.org/pdf/1812.03982.pdf, which is hereby incorporated by reference in its entirety. However, the SlowFast network uses separate networks to extract spatial information and temporal information, whereas the presently described example 3D convolution blocks may perform both functions using a single convolution block.

The multi-bandwidth convolution layer described herein uses repeated down-sampling to provide input channels to progressively lower-bandwidth branches progressively increases receptive field and may enhance the feature extraction ability of the convolution block and therefore the inferential ability of the overall network. Since the lower-bandwidth branches have relatively low computation costs, any added complexity in network architecture that is associated with managing the input splitting, down-sampling, and up-sampling of lower-bandwidth branches may be configured in some embodiments such that it does not significantly affect the computational efficiency of the overall multi-bandwidth convolution block relative to a conventional convolution block.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure, are incorporated herein by reference.

Further aspects and examples of the present disclosure are presented in the Appendix attached hereto, the entirety of which is hereby incorporated into the present disclosure.

1. A method for performing operations of a multi-bandwidth separated feature extraction convolutional layer of a convolutional neural network, the method comprising:
receiving an input activation map comprising a plurality of input channels;
grouping the plurality of input channels into a plurality of subsets of input channels including a first subset of input channels and a second subset of input channels;
convolving each respective input channel of the first subset of input channels with each convolutional kernel of a first set of convolution kernels to generate a set of full-bandwidth output channels;
down-sampling each respective input channel of the second subset of input channels by a scaling factor to generate a first set of down-sampled channels;
convolving each respective down-sampled channel with each convolution kernel of a second set of convolution kernels to generate a set of down-sampled output channels, each down-sampled output channel having a smaller number of elements, by a factor of the scaling factor, than one of the full-bandwidth output channels;
for each respective down-sampled output channel of the set of down-sampled output channels, shuffling the pixels of the respective down-sampled output channel into an up-sampled output channel having the same size as a full-bandwidth output channel, thereby generating a first set of up-sampled output channels; and
generating an output activation map by concatenating the set of full-bandwidth output channels and the first set of up-sampled output channels.

2. The method of claim 1, further comprising:
further grouping the plurality of input channels into one or more additional subsets of input channels; and
for each additional subset of input channels:
down-sampling each input channel of the additional subset of input channels by a distinct additional scaling factor to generate an additional set of down-sampled channels;
convolving the down-sampled channels with a distinct additional set of convolution kernels to generate an additional set of down-sampled output channels, each down-sampled output channel having a smaller number of elements, by a factor of the distinct additional scaling factor, than one of the full-bandwidth output channels; and
for each respective down-sampled output channel, shuffling the pixels of the respective down-sampled output channel into a single up-sampled output channel having the same size as a full-bandwidth output channel, thereby generating an additional set of up-sampled output channels,
and wherein generating the output activation map further comprises concatenating each additional set of up-sampled output channels with the set of full-bandwidth output channels and the first set of up-sampled output channels.

3. The method of claim 2, wherein:
shuffling the pixels of a set of down-sampled channels into a single up-sampled output channel comprises generating an output channel comprising a plurality of pixel clusters, each pixel cluster comprising one pixel selected from each down-sampled channel of the set of down-sampled channels.

4. The method of claim 1, further comprising:
using the output activation map to generate an inference;
calculating a loss function based on the inference; and
updating each set of convolution kernels based on the calculated loss function.

5. The method of claim 4, further comprising, for each set of convolution kernels:
prior to convolving each subset of input channels with its respective set of convolution kernels:
learning a set of frequency-based attention multipliers;
applying the set of frequency-based attention multipliers to the weights of the set of convolution kernels; and
applying a magnitude-based attention function to the weights of the set of convolution kernels.

6. The method of claim 5, further comprising:
prior to calculating the loss function, applying a frequency-based attention function to the output activation map.

7. The method of claim 6, wherein learning each set of frequency-based attention multipliers comprises:
standardizing the weights in the set of convolution kernels;
applying a Fourier transform function to the set of convolution kernels to generate a set of frequency-domain convolution kernels;
performing average pooling to obtain an averaged weight for each frequency-domain convolution kernel;
feeding the averaged weights of the frequency-domain convolution kernels through one or more fully connected layers of the convolutional neural network, to learn the attention multiplier for each frequency-domain convolution kernel; and
expanding the attention multiplier across all weights in each respective convolution kernel to obtain the set of frequency-based attention multipliers, and wherein applying the set of frequency-based attention multipliers to the weights of each set of convolution kernels comprises:
multiplying the set of frequency-based attention multipliers by the set of frequency-domain convolution kernels to generate a set of attention-infused frequency-domain convolution kernels; and
applying a reverse Fourier transform function to the set of attention-infused frequency-domain convolution kernels.

8. The method of claim 7, wherein:
there are two fully connected layers for learning the attention multiplier for each convolution kernel;
the magnitude-based attention function applies greater attention to weights of greater magnitude, and lesser attention to weights of lesser magnitude; and
the magnitude-based attention function is
$${w}_{A} = {f}_{A} ( {w}_{m} ) = {M}_{A} * 0.5 * ln \frac{1 + {w}_{m} / {M}_{A}}{1 - {w}_{m} / {M}_{A}}$$
wherein wₘ is a weight for a convolution kernel, w_{A} is the weight after applying magnitude-based attention, M_{A}=(1+ϵ_{A})*M, M is the maximum of all wₘ in a convolution layer and ϵ_{A} is a hyperparameter with a selected small value.

9. The method of claim 1, wherein concatenating the set of full-bandwidth output channels and the first set of up-sampled output channels to generate the output activation map comprises:
receiving the set of full-bandwidth output channels and the first set of up-sampled output channels at a shuffled concatenation block; and
concatenating the output channels of the set of full-bandwidth output channels and the output channels of the first set of up-sampled output channels according to a shuffling pattern such that at least one output channel of the first set of up-sampled output channels is concatenated in order after a first output channel of the set of full-bandwidth output channels and in order before a second output channel of the set of full-bandwidth output channels.

10. The method of claim 9, wherein the shuffling pattern is a skip-by-S shuffling pattern, S being a positive integer.

11. A system for performing operations of a multi-bandwidth separated feature extraction convolutional layer of a convolutional neural network, comprising a processor and a memory storing instructions which, when executed by the processor device, cause the system to:
receive an input activation map comprising a plurality of input channels;
group the plurality of input channels into a plurality of subsets of input channels including a first subset of input channels and a second subset of input channels;
convolve each respective input channel of the first subset of input channels with each convolutional kernel of a first set of convolution kernels to generate a set of full-bandwidth output channels;
down-sample each respective input channel of the second subset of input channels by a scaling factor to generate a first set of down-sampled channels;
convolve each respective down-sampled channel with each convolution kernel of a second set of convolution kernels to generate a set of down-sampled output channels, each down-sampled output channel having a smaller number of elements, by a factor of the scaling factor, than one of the full-bandwidth output channels;
for each respective down-sampled output channel of the set of down-sampled output channels, shuffle the pixels of the respective down-sampled output channel into an up-sampled output channel having the same size as a full-bandwidth output channel, thereby generating a first set of up-sampled output channels; and
generate an output activation map by concatenating the set of full-bandwidth output channels and the first set of up-sampled output channels.

12. The system of claim 11, wherein the instructions, when executed by the processor device, further cause the system to:
further group the plurality of input channels into one or more additional subsets of input channels; and
for each additional subset of input channels:
down-sample each input channel of the additional subset of input channels by a distinct additional scaling factor to generate an additional set of down-sampled channels;
convolve the down-sampled channels with a distinct additional set of convolution kernels to generate an additional set of down-sampled output channels, each down-sampled output channel having a smaller number of elements, by a factor of the distinct additional scaling factor, than one of the full-bandwidth output channels; and
for each respective down-sampled output channel, shuffle the pixels of the respective down-sampled output channel into a single up-sampled output channel having the same size as a full-bandwidth output channel, thereby generate an additional set of up-sampled output channels,
and wherein generating the output activation map further comprises concatenating each additional set of up-sampled output channels with the set of full-bandwidth output channels and the first set of up-sampled output channels.

13. The system of claim 12, wherein:
shuffling the pixels of a set of down-sampled channels into a single up-sampled output channel comprises generating an output channel comprising a plurality of pixel clusters, each pixel cluster comprising one pixel selected from each down-sampled channel of the set of down-sampled channels.

14. The system of claim 11, wherein the instructions, when executed by the processor device, further cause the system to:
use the output activation map to generate an inference;
calculate a loss function based on the inference; and
update each set of convolution kernels based on the calculated loss function.

15. The system of claim 14, wherein the instructions, when executed by the processor device, further cause the system to, for each set of convolution kernels:
prior to convolving each subset of input channels with its respective set of convolution kernels:
learn a set of frequency-based attention multipliers;
apply the set of frequency-based attention multipliers to the weights of the set of convolution kernels; and
apply a magnitude-based attention function to the weights of the set of convolution kernels.

16. The system of claim 15, wherein the instructions, when executed by the processor device, further cause the system to:
prior to calculating the loss function, apply a frequency-based attention function to the output activation map.

17. The system of claim 16, wherein learning each set of frequency-based attention multipliers comprises:
standardizing the weights in the set of convolution kernels;
applying a Fourier transform function to the set of convolution kernels to generate a set of frequency-domain convolution kernels;
performing average pooling to obtain an averaged weight for each frequency-domain convolution kernel;
feeding the averaged weights of the frequency-domain convolution kernels through one or more fully connected layers of the convolutional neural network, to learn the attention multiplier for each frequency-domain convolution kernel; and
expanding the attention multiplier across all weights in each respective convolution kernel to obtain the set of frequency-based attention multipliers, and wherein applying the set of frequency-based attention multipliers to the weights of each set of convolution kernels comprises:
multiplying the set of frequency-based attention multipliers by the set of frequency-domain convolution kernels to generate a set of attention-infused frequency-domain convolution kernels; and
applying a reverse Fourier transform function to the set of attention-infused frequency-domain convolution kernels.

18. The system of claim 17, wherein:
there are two fully connected layers for learning the attention multiplier for each convolution kernel;
the magnitude-based attention function applies greater attention to weights of greater magnitude, and lesser attention to weights of lesser magnitude; and
the magnitude-based attention function is
$${w}_{A} = {f}_{A} ( {w}_{m} ) = {M}_{A} * 0.5 * ln \frac{1 + {w}_{m} / {M}_{A}}{1 - {w}_{m} / {M}_{A}}$$
where wₘ is a weight for a convolution kernel, w_{A} is the weight after applying magnitude-based attention, M_{A}=(1+ϵ_{A})*M, M is the maximum of all wₘ in a convolution layer and ϵ_{A} is a hyperparameter with a selected small value.

19. The system of claim 11, wherein concatenating the set of full-bandwidth output channels and the first set of up-sampled output channels to generate the output activation map comprises:
receiving the set of full-bandwidth output channels and the first set of up-sampled output channels at a shuffled concatenation block; and
concatenating the output channels of the set of full-bandwidth output channels and the output channels of the first set of up-sampled output channels according to a shuffling pattern such that at least one output channel of the first set of up-sampled output channels is concatenated in order after a first output channel of the set of full-bandwidth output channels and in order before a second output channel of the set of full-bandwidth output channels.

20. A computer-readable medium having instructions tangibly stored thereon, wherein the instructions, when executed by a processing unit, causes the processing unit to perform the method of claim 1.
